(19) United States
(12) Patent Application Publication
(10) Pub. No.: US 2018/0062273 A1
(43) Pub. Date: Mar. 1, 2018

(54) EQUATORIALLY AND NEAR-EQUATORIALLY RADIATING ARC-SHAPED POLARIZATION CURRENT ANTENNAS AND RELATED METHODS

(71) Applicants: Arzhang Ardavan, Oxford (GB); Houshang Ardavan, Cambridge (GB)

(72) Inventors: Arzhang Ardavan, Oxford (GB); Houshang Ardavan, Cambridge (GB)

(21) Appl. No.: 15/709,588

(22) Filed: Sep. 20, 2017

Related U.S. Application Data
(63) Continuation-in-part of application No. 15/631,413, filed on Jun. 23, 2017.
(60) Provisional application No. 62/355,478, filed on Jun. 28, 2016.
(60) Provisional application No. 62/399,716, filed on Sep. 26, 2016.

(51) Int. Cl. H01Q 21/20; H01Q 7/00; H01Q 11/18; H01Q 1/24

(52) U.S. Cl. CPC H01Q 21/20; H01Q 1/246; H01Q 11/18; H01Q 7/00

(57) ABSTRACT

Polarization current antennas include an arc-shaped dielectric radiator, electrodes, and a feed network. The electrodes and feed network are configured to generate an electric field within the dielectric radiator. The electrodes are positioned on the top and bottom of the dielectric radiator and the electromagnetic radiation is emitted through the outer surface thereof. Phase differences between excitation signals supplied to the electrodes may be selected so that a speed of a volume polarization distribution current pattern that is generated in the dielectric radiator will be substantially equal to the speed of light within the dielectric radiator. The antenna emits both conventional spherically decaying electromagnetic radiation and as non-spherically decaying electromagnetic radiation that decays as a function of distance d at a rate that is less than 1/d². The non-spherically decaying radiation includes a highly focused beam that has an angular beamwidth that narrows as the distance d increases.

### CROSS-REFERENCE TO RELATED APPLICATIONS

This application claims priority under 35 U.S.C. § 120 as a continuation-in-part of U.S. patent application Ser. No. 15/631,413, filed Jun. 23, 2017, which in turn claims priority under 35 U.S.C. § 119 to U.S. Provisional Patent Application Ser. No. 62/355,478, filed Jun. 28, 2016, and to U.S. Provisional Patent Application Ser. No. 62/399,716, filed Sep. 26, 2016, the entire content of each of which are incorporated herein by reference in their entireties.

### BACKGROUND

Antennas that include a dielectric radiator that is excited using a series of polarization devices are known in the art. Such antennas are referred to herein as “polarization current antennas.” An example of such a polarization current antenna is disclosed in European Patent No. 1112578 titled “Apparatus for Generating Focused Electromagnetic Radiation,” filed on Sep. 6, 1999. Each polarization device may comprise, for example, a pair of electrodes that are positioned on opposite sides of a ring-shaped dielectric radiator. The dielectric radiator may be a continuous dielectric element, and the electrode pairs may be positioned side-by-side on inner and outer sides thereof. Each pair of electrodes and the portion of the dielectric radiator therebetween forms a “polarization element” of the polarization current antenna.

The above-described polarization current antenna may operate as follows. When a voltage is applied across one of the electrode pairs, an electric field is generated across the portion of the dielectric radiator therebetween. The electric field generates a displacement current within the dielectric radiator. This displacement current may be referred to as a “volume polarization current” because the current is generated by polarizing the portion of the dielectric material that is between the electrode pair throughout its volume. The generated volume polarization current emits electromagnetic radiation. A volume polarization current distribution pattern may be generated in the dielectric radiator by applying different voltages across multiple of the electrode pairs. Moreover, this volume polarization current distribution pattern may be caused to propagate within the dielectric radiator by appropriate sequencing of the energization of the electrode pairs. One example of a moving volume polarization current distribution pattern is a polarization current wave such as, for example, a sinusoidal polarization current wave that propagates through the dielectric radiator. This polarization current wave can be made to propagate through the dielectric radiator in a direction orthogonal to a vector extending between the electrodes of an electrode pair. Polarization current antennas that have dielectric radiators that are driven by individual amplifiers are known in the art. See U.S. Pat. No. 8,125,385, titled “Apparatus and Methods for Phase Fronts Based on Superluminal Polarization Current,” filed Aug. 13, 2008, which is incorporated herein by reference. Polarization current antennas that are driven by passive feed networks are also known in the art. See International Patent Publication No. WO/2014/100008, which is also incorporated herein by reference. Polarization current antennas differ from conventional antennas in that their emission of electromagnetic radiation arises from a polarization current rather than a conduction or convection electric current.

Polarization current antennas that generate polarization current waves that move faster than the speed of light in a vacuum have been experimentally realized. One example of such a polarization current antenna that has already been constructed and tested functions by generating a rotating polarization current wave in a dielectric radiator that is implemented as a ring-shaped block of dielectric material. By phase-controlled excitation of the voltages that are applied to electrodes that surround the dielectric radiator, a volume polarization current can be generated that has a moving distribution pattern (i.e., a polarization current wave that travels along the dielectric radiator) that changes faster than the speed of light and exhibits centripetal acceleration. See, e.g., U.S. Patent Publication No. 2006/0192504 (“the '504 publication”); see also, U.S. patent application Ser. No. 13/368,200, titled “Superluminal Antenna” filed on Feb. 7, 2012, the disclosures of each of which are incorporated herein by reference. It should be noted that while the polarization current wave travels faster than the speed of light, the movements of the underlying charged particles that create the polarization current wave are subluminal.

FIG. 1 is a perspective view of the polarization current antenna 1 that is disclosed in the '504 publication. As shown in FIG. 1, the polarization current antenna 1 includes a ring-shaped dielectric radiator 2 that has a plurality of inner electrodes 4 that are disposed on an inner surface of the ring-shaped dielectric radiator 2 and a plurality of outer electrodes 6 that are disposed on an outer surface of the ring-shaped dielectric radiator 2. The ring-shaped dielectric radiator 2 circles an axis of rotation z. The polarization current antenna 1 of FIG. 1 produces tightly-focused packets of electromagnetic radiation that are fundamentally different from the emissions of conventional antennas.

Polarization current antennas that generate polarization current waves that move faster than the speed of light can make contributions at multiple “retarded times” to a signal received instantaneously at a location remote from the polarization current antenna. The location where the electromagnetic radiation is received may be referred to herein as an “observation point,” and each “retarded time” refers to the earlier time at which a specific portion of the electromagnetic radiation that is received at the observation point at the observation time was generated by the volume polarization current. The contributions to the electromagnetic radiation made by the volume elements of the polarization current that approach the observation point, along the radiation direction, with the speed of light and zero acceleration at the retarded time, may coalesce and give rise to a focusing of the received waves in the time domain. In other words, waves of electromagnetic radiation that were generated by a volume element of the polarization current at different points in time can arrive at the same time at the observation point. The interval of time during which a particular set of electromagnetic waves is received at the observation point is considerably shorter than the interval of time during which the same set of electromagnetic waves is emitted by the polarization current antenna. As a result, part of the electromagnetic radiation emitted by the polarization current antenna possesses an intensity that decays non-spherically with a distance d from the antenna as 1/d^{α} with 1<α<2 rather than as the conventional inverse square law, 1/d². This does not contravene the physical law of conservation of energy. The constructively interfering waves from the particular set of volume elements of the polarization current that are responsible for the non-spherically decaying signal at a given observation point constitute a radiation beam for which the time-averaged value of the temporal rate of change of energy density is always negative. For this non-spherically decaying radiation, the flux of energy into a closed region (e.g., into the volume bounded by two large spheres centered on the source) is smaller than the flux of energy out of it because the amount of energy contained within the region decreases with time. (The area subtended by the beam increases as d², so that the flux of energy increases with distance as d^{2-α} across all cross sections of the beam.) In that it consists of caustics and so is constantly dispersed and reconstructed out of other electromagnetic waves, the beam in question has temporal characteristics radically different from those of a conventional beam of electromagnetic radiation.

### BRIEF DESCRIPTION OF THE FIGURES

FIG. 1 is a schematic perspective view of a known polarization current antenna.

FIGS. 2 and 3 are schematic side views of a device that includes a dielectric radiator, a ground plane and a single upper electrode that illustrate how a volume polarization current can be induced in a dielectric radiator.

FIGS. 4 and 5 are schematic side views of a polarization current antenna that includes a dielectric radiator, a ground plane and a plurality of upper electrodes that illustrate how a volume polarization current distribution pattern can be generated and made to move within the dielectric radiator.

FIG. 6 is a graph illustrating the application of discretized sinusoidally varying voltages to the polarization elements of a polarization current antenna at four equally-spaced consecutive time intervals.

FIG. 7 is a schematic perspective view of a polarization current antenna according to embodiments of the present invention that has a closed arc or “ring” shape.

FIG. 7A is a schematic perspective view of the dielectric radiator included in the polarization current antenna of FIG. 7.

FIG. 8 is a schematic perspective view of a polarization current antenna according to further embodiments of the present invention that has an arc shape.

FIG. 8A is a schematic perspective view of the dielectric radiator included in the polarization current antenna of FIG. 8.

FIG. 9 is a schematic diagram that illustrates the azimuthal beamwidth of the polarization current antenna of FIG. 8.

FIG. 10 is a graph of the directive gain for a polarization current antenna according to embodiments of the present invention as a function of the polar coordinate of observation points that are at a fixed distance from the antenna.

FIG. 10A is a graph comparing the radiation distribution pattern of FIG. 10 to the radiation distribution pattern of a stationary source.

FIG. 11 is a graph that illustrates the location of the dielectric radiator of a polarization current antenna according to embodiments of the present invention and how the projection of the cusp associated with a selected observation point onto a meridional plane may pass through the dielectric radiator dividing it into two regions with differing radiative properties.

FIG. 12 is a graph that translates the data included in the graphs of FIG. 10 and FIG. 13 into a polar coordinate system.

FIG. 13 is graph of the directive gain for a polarization current antenna according to embodiments of the present invention as a function of the polar coordinate of observation points that are at six different distances from the antenna.

FIG. 14 is a schematic diagram illustrating the different components of the radiation emitted by a polarization current antenna according to embodiments of the present invention in one direction.

FIG. 15 is logarithmic plot of the radial component of the normalized Poynting vector versus the normalized distance along the generating line of a cone inside the solid angle where the radiation decays non-spherically.

FIG. 16 is graph of the exponent a of the distance dependence \hat{R}_{P}^{-α} of the radial component of the Poynting vector over the range \hat{R}_{P}=10 to \hat{R}_{P}=10⁶ as a function of the polar angle θ_{P} for values of θ_{P} in the range 56.4<θ_{P}≦90°.

FIG. 17 is a graph of the directive gain as a function of the polar coordinate of observation points that are at a fixed distance for a polarization current antenna according to further embodiments of the present invention that generates a radiation pattern having a peak amplitude that is outside the equatorial plane.

FIG. 18 is graph of the flux density of radiation as a function of the polar coordinate of observation points that are at six different distances for the polarization current antenna corresponding to FIG. 17.

FIG. 19 is a graph that translates the data included in the graphs of FIG. 17 and FIG. 18 into a polar coordinate system.

FIG. 20 is graph of the exponent α of the distance dependence \hat{R}_{P}^{-α} of the radial component of the Poynting vector over the range \hat{R}_{P}=10 to \hat{R}_{P}=10⁶ as a function of the polar angle θ_{P} for the polarization current antenna corresponding to FIGS. 17-19.

FIG. 21 is a graph of the directive gain as a function of the polar coordinate of observation points that are at a fixed distance for a polarization current antenna having the design of FIG. 1.

FIG. 22 is graph of the flux density of radiation as a function of the polar coordinate of observation points that are at six different distances for the polarization current antenna corresponding to FIG. 21.

FIG. 23 is a graph that translates the data included in the graphs of FIG. 21 and FIG. 22 into a polar coordinate system.

FIG. 24 is graph of the exponent a of the distance dependence \hat{R}_{P}^{-α} of the radial component of the Poynting vector over the range \hat{R}_{P}=10 to \hat{R}_{P}=10⁶ as a function of the polar angle θ_{P} for the polarization current antenna corresponding to FIGS. 21-23.

FIG. 25 is a graph illustrating the fractions of linear polarization and circular polarization as a function of the polar angle θ_{P} for the radiation generated by the polarization current antenna used in the modelling results of FIGS. 21-24 at \hat{R}_{P}=10².

FIG. 26 is a graph of the polarization position angle as a function of the polar angle θ_{P} for the radiation generated by the polarization current antenna used in the modelling results of FIGS. 21-24 at \hat{R}_{P}=10².

FIG. 27 is a schematic diagram illustrating a base station that uses polarization current antennas according to embodiments of the present invention.

### DETAILED DESCRIPTION

Pursuant to embodiments of the present invention, arc-shaped (including ring-shaped) polarization current antennas are provided that emit electromagnetic radiation along or near an equator of the arc. These polarization current antennas may comprise an arc-shaped dielectric radiator and a plurality of polarization devices that together form a plurality of polarization elements. Each polarization device may comprise, for example, a pair of electrodes. The electrodes may, for example, be disposed on top and bottom surfaces of the arc-shaped dielectric radiator to facilitate equatorial (or near-equatorial) emission of electromagnetic radiation by the polarization current antenna. The radius of the arc-shaped dielectric radiator may define a circle that lies in a horizontal plane. The “equator” of the arc lies in this horizontal plane. A vertical axis of rotation z (see FIG. 1) may be defined at the center of the circle defined by the radius. The arc-shaped dielectric radiator extends around this axis of rotation z.

The peak emission of the electromagnetic radiation emitted by the polarization elements of the polarization current antenna may be directed at an angle from the horizontal plane that is referred to herein as an “elevation angle.” The phase difference between the oscillations of the elements of the arc-shaped dielectric radiator and various other parameters of the polarization current antenna may be selected based on a center frequency of a signal that is to be transmitted by the polarization current antenna to achieve peak emission at a desired elevation angle. In some embodiments, the desired elevation angle may be an elevation angle of between −10° and 10° with respect to the equatorial plane. In some embodiments, the desired elevation angle may be an elevation angle of substantially zero with respect to the equatorial plane. In some embodiments, the desired elevation angle may be an elevation angle of between −5° and 5° with respect to the equatorial plane. In some embodiments, polarization current antennas having arc-shaped dielectric radiators are provided that are configured so that the polarization current waves generated therein travel at a speed that is less than c within a first portion of the arc-shaped dielectric radiator and at a speed that is greater than or equal to c within a second portion of the arc-shaped dielectric radiator, where c is the speed of light in vacuum. The first portion may be an inner portion of the arc-shaped dielectric radiator and the second portion may be an outer portion of the arc-shaped dielectric radiator. In some embodiments, the polarization current antennas may be configured so that the polarization current wave travels at the speed of between c and 1.02*c within a portion of the dielectric radiator. In each of the above cases this configuration may be designed to result in equatorial or near-equatorial emission. In some embodiments, the polarization current antennas may be configured so that the polarization current wave travels at the speed of light within at least a portion of the dielectric radiator in order to, for example, cause the polarization current antenna to emit radiation equatorially. As shown herein, enhanced emission may be obtained with equatorial and/or near equatorial emission. A height of the arc-shaped dielectric radiator (i.e., a distance that the arc extends in a direction parallel to the axis of rotation z) may be selected to provide a desired elevation beamwidth in some embodiments.

The polarization current antennas according to embodiments of the present invention may include a plurality of polarization elements that together form a volume polarization current distribution radiator. Each polarization element may comprise a pair of electrodes (or other polarization device) and an associated segment of a dielectric radiator. In some embodiments, a single continuous dielectric radiator may be used, respective segments of which comprise parts of the individual polarization elements. In other embodiments, the dielectric radiator may comprise a plurality of discrete dielectric elements that together form the dielectric radiator (e.g., each polarization element may have its own discrete dielectric element and these dielectric elements may together form the dielectric radiator). The polarization elements may be arranged in an arc having a radius r about the axis of rotation z. The polarization elements may be oriented such that the dielectric radiator faces outwardly, away from the axis of rotation z, and the electrodes may be placed on top and bottom surfaces of the dielectric radiator. The dielectric radiator has a finite polarization region that is created by selectively applying a voltage to one or more electrodes. In some embodiments, the electrodes are excited such that a polarization current wave propagates along the dielectric radiator at about the speed of light. The polarization current wave propagates from polarization element to polarization element about the axis of rotation z.

Thus, pursuant to embodiments of the present invention, polarization current antennas having arc-shaped dielectric radiators are provided which emit a beam of electromagnetic radiation from an outer surface of the arc-shaped dielectric radiator. As the electrodes or other polarization devices may be disposed adjacent the top and bottom surfaces of the arc-shaped dielectric radiator, the electrodes may not block or otherwise interfere with the beam of electromagnetic radiation that is emitted from the outer surface of the arc-shaped dielectric radiator. In some embodiments, these polarization current antennas may be configured so that a polarization current wave is generated in the arc-shaped dielectric radiator that travels at the speed of light within a portion (e.g., the center) of the dielectric radiator. In some embodiments, the polarization current wave may travel subluminally in other (e.g., inner) portions of the dielectric radiator and may travel superluminally in still other (e.g., outer) portions of the dielectric radiator.

Before describing various embodiments of the present invention in greater detail, the configuration and operation of polarization current antennas will first be described in more detail.

In a conventional phased array antenna, a plurality of dipole, patch or other radiating elements are used to transmit and receive radio frequency (RF) signals. In these conventional antennas, each radiating element may be considered a point source of electromagnetic radiation. The radiating elements may be separated by a distance that is proportional to the wavelength of an RF signal that is emitted by the radiating elements. The electromagnetic radiation is generated by surface currents, such as surface currents generated on the dipole or patch radiating elements.

In contrast to such point-source electromagnetic radiation sources, the polarization current antennas according to embodiments of the present invention produce a continuous, moving source of electromagnetic radiation that is distributed over a volume. In some embodiments, this source may be a polarization current wave that flows through a dielectric radiator.

The production and propagation of electromagnetic radiation in the polarization current antennas according to embodiments of the present invention is described by the following two of Maxwell equations:

∇×E=∂B/∂t (1)

∇×H=J_{free}+ε₀∂E/∂t+∂P/∂t (2)

In Equations (1) and (2), H is the magnetic field strength, B is the magnetic induction, P is polarization, and E is the electric field, and all terms are in SI units. The (coupled) terms in B, E and H of Equations (1) and (2) describe the propagation of electromagnetic radiation. The generation of electromagnetic radiation is encompassed by the source terms J_{free} (the current density of free charges) and ∂P/∂t (the polarization current density). An oscillating J_{free} is the basis of conventional radio transmission. The charged particles that make up J_{free} have finite rest mass, and therefore cannot move with a speed that exceeds the speed of light in vacuo. Practical polarization current antennas employ a volume polarization current to generate electromagnetic radiation, which is represented by the volume polarization current density ∂P/∂t.

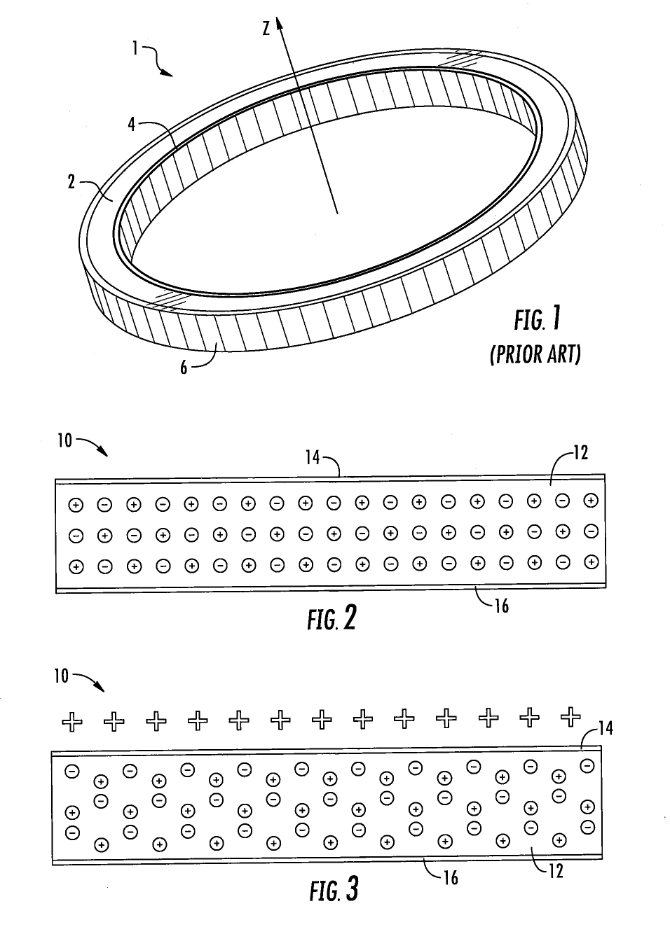

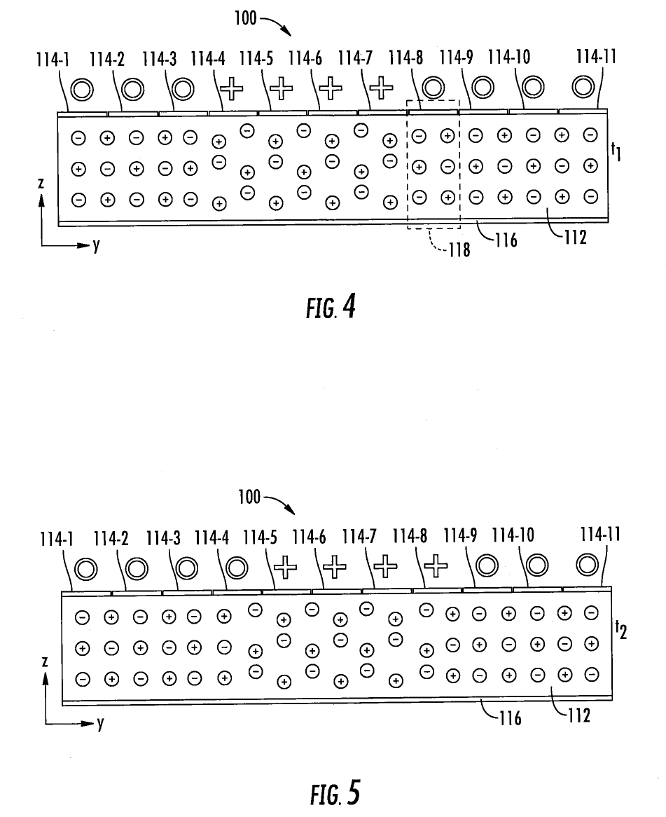

The principles of such polarization current antennas will now be described with reference to FIGS. 2-5. FIGS. 2 and 3 schematically illustrate a device 10 that includes a dielectric radiator 12. An electrode 14 is provided on one side of the dielectric radiator 12 and a ground plane 16 is provided on the other (opposite) side of the dielectric radiator 12. The dielectric radiator 12 is an electrical insulator that may be polarized by applying an electric field thereto. When the electric field is applied to the dielectric radiator 12, electric charges in the portion of the dielectric radiator 12 effected by the electrical field shift from their average equilibrium positions causing polarization in this portion of the dielectric radiator 12. When the dielectric radiator 12 is polarized, positive charges are displaced in the same direction as that of the electric field and negative charges shift in the opposite direction away from the electric field.

In the example of FIG. 2, no electric field is applied across the dielectric radiator 12 via the electrode 14 and ground plane 16, so the charges in the dielectric radiator 12 are shown as being randomly distributed to indicate that they are in their average equilibrium positions. In the example of FIG. 3, a voltage has been applied to the electrode 14 to generate an electric field across the dielectric radiator 12. As shown in FIG. 3, in response to this voltage, the positive and negative charges shift slightly from their average equilibrium positions (see FIG. 2) to move in opposite directions with the negative charges shifting towards the applied voltage and the positive charges shifting away from the applied voltage. A finite polarization P has therefore been induced in the dielectric radiator 12. A changing state of polarization P corresponds to charge movement, and so is equivalent to current. Thus, changes to the state of the polarization P of the dielectric radiator 12—such as the change shown between FIGS. 2 and 3 —may generate electromagnetic radiation.

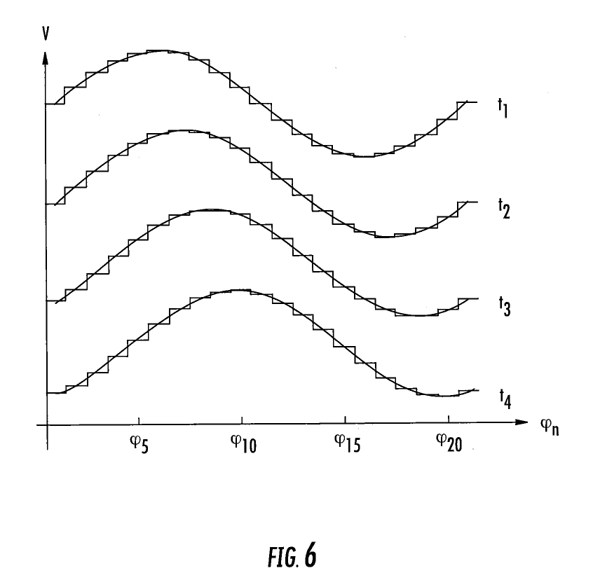

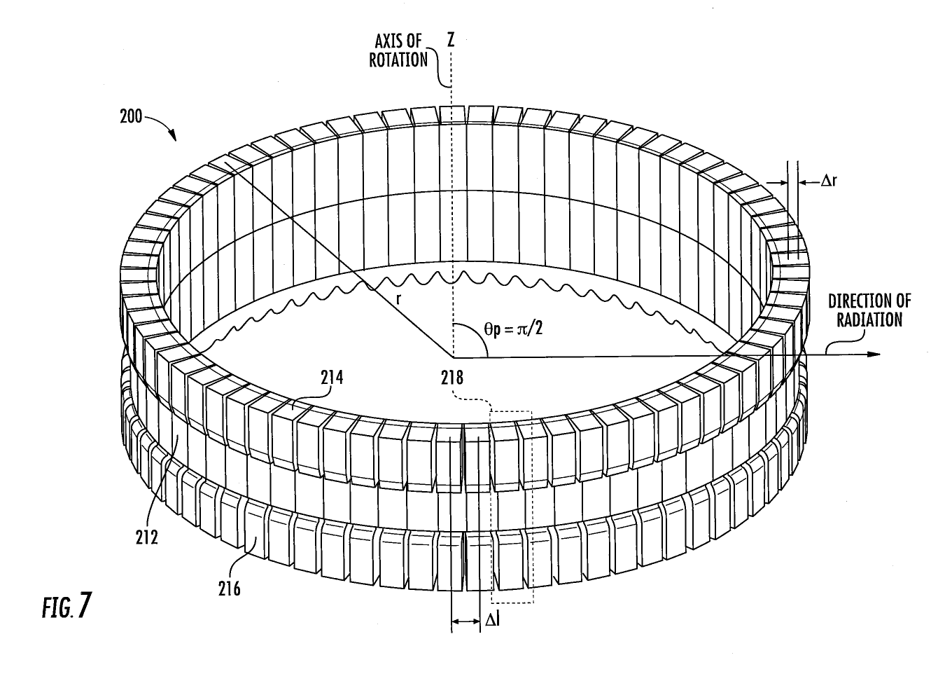

FIGS. 4 and 5 illustrate a portion of a polarization current antenna 100. The polarization current antenna 100 is similar to the device 10 of FIGS. 2 and 3, and includes a dielectric radiator 112 and a ground plane 116 that may be identical to the dielectric radiator 12 and the ground plane 16, respectively, of the device 10 of FIGS. 2-3. The polarization current antenna 100 of FIGS. 4 and 5 differs from the device 10 of FIGS. 2-3 in that the common electrode 14 of the device 10 of FIGS. 2-3 has been replaced with a plurality of smaller, individual electrodes labeled 114-1 through 114-11 (which are collectively referred to herein as the electrodes 114) that are arranged in a side-by-side relationship. Each electrode 114, in conjunction with a portion of the dielectric radiator 112 and a portion of the ground plane 116, forms a polarization element 118 of the polarization current antenna 100. One such polarization element 118 is shown in the dashed box in FIG. 4. The polarization current antenna 100 has a total of twenty polarization elements 118, but only the first eleven polarization elements 118 are shown to simplify the drawings.

As a plurality of separate electrodes 114 are provided in the polarization current antenna 100 of FIGS. 4-5, a spatially-varying electric field may be applied across the dielectric radiator 112 by simultaneously applying different voltages to different ones of the electrodes 114. Moreover, the distribution pattern of the electric field can be made to move by, for example, applying voltages in sequence to the electrodes 114. In particular, if the distribution pattern of the spatially-varying electric field is made to move, then the polarized region moves with it; thereby producing a traveling “wave” of P that moves along the dielectric radiator 112 (and also, by virtue of the time dependence imposed by movement, a traveling wave of ∂P/∂t). As noted above, this traveling “wave” of P may be referred to herein as a “polarization current wave.” This polarization current wave generates electromagnetic radiation as it moves along the dielectric radiator 112. While the description that follows will primarily focus on polarization current waves that move through a dielectric radiator, it will be appreciated that volume polarization current distribution patterns other than polarization current waves may be made to move through the dielectric radiator. Embodiments of the present invention encompass such moving but non-wave-like volume polarization current distribution patterns.

FIGS. 4 and 5 illustrate how a polarization current wave may be created and made to move through the dielectric radiator 112. In particular, FIG. 4 illustrates the position of a polarized region of the dielectric radiator 112 at time t₁. As shown in FIG. 4, at time t₁ electrodes 114-1 through 114-3 and 114-8 through 114-11 are not energized (shown by the “O” above the individual electrodes 114), while a voltage is applied to electrodes 114-4 through 114-7 (shown by the “+” above the individual electrodes 114). In this state, an electric field exists between electrodes 114-4 through 114-7 and the ground plane 116, and therefore a polarized region also exists in the dielectric radiator 112 adjacent to electrodes 114-4 through 114-7. The state of the antenna 100 at time t₂ is illustrated in FIG. 5. At time t₂, the voltage is removed from electrode 114-4 and a voltage is applied to electrode 114-8. The electric field, and therefore the polarized region, has moved one electrode 114 to the right. In other words, FIGS. 4-5 illustrate the movement of a polarization current wave from the region of dielectric radiator 112 underneath electrodes 114-4 through 114-7 (see FIG. 4) to the region of dielectric radiator 112 underneath electrodes 114-5 through 114-8 (see FIG. 5). Note that this polarization current wave can move arbitrarily fast (including faster than the speed of light in vacuo) because the polarization current wave is generated by movement of charges in a first direction (i.e., the vertical direction in FIGS. 4-5) while the polarization current wave moves in a second direction that is orthogonal to the first direction (i.e., the horizontal direction in FIGS. 4-5 as the polarization current wave moves along the dielectric radiator 112). Thus, the individual charges do not themselves move faster than the speed of light, while the polarization current wave may be made to move faster than the speed of light. As a simple example, this phenomenon is akin to a “wave” that is created by fans standing up and sitting down in a stadium during an athletic event. The speed at which the wave moves through the stadium is a function of a number of factors, only one of which is the speed at which the individual spectators stand up and sit down, and hence the speed of the wave can be made to be faster than the speed at which the individuals creating the wave move.

The polarization current antenna 100 may be used, for example, to transmit an information signal. Typically, radio frequency communications involves modulating an information signal onto a carrier signal, where the carrier signal is typically a sinusoidal signal having a frequency in a desired frequency band of operation. By way of example, the various different cellular communications networks have fixed frequency bands of operation in which the signals that are transmitted between base stations and mobile terminals are transmitted at frequencies within the specified frequency band. One way to use the polarization current antenna 100 to transmit an information signal is to modulate the information signal onto a sinusoidal waveform that oscillates at a desired radio frequency (“RF”) such as, for example, 2.5 GHz, and to use this modulated RF signal to excite the electrodes of the polarization current antenna 100. This can be accomplished using, for example, a passive corporate feed network in some embodiments. The corporate feed network is used to divide the modulated RF signal into a plurality of sub-components with differing phases. The number of sub-components may be equal to the number of polarization elements 118 included in the polarization current antenna 100, so that a sub-component of the modulated RF signal is applied to, for example, each electrode 114. In some embodiments, the magnitude of each sub-component of the RF signal may be proportional to that of the modulated RF signal to be transmitted.

With this approach, at any given point in time, a sub-component of the modulated RF signal is applied to each of the polarization elements 118. At a first point in time t₁, the applied modulated RF signal will have a given amplitude. However, the sub-components of the modulated RF signal that are applied to different polarization elements 118 have different phase offsets, and hence their magnitude will vary as the modulated RF signal varies with time. At a subsequent point in time t₂, the magnitude of the modulated RF signal at any given polarization element 118 will have changed in a known manner based on the frequency of the signal and the time difference t₂-t₁. This is shown graphically in FIG. 6.

In particular, FIG. 6 illustrates the voltages Vⱼ that may be applied to the upper electrodes 114 of the polarization current antenna 100. The lower electrode 116 may be connected to a constant reference voltage such as a ground voltage. The four separate curves in FIG. 6 illustrate the voltages Vⱼ applied to the upper electrodes 114 of the twenty polarization elements 118 (note that FIGS. 4 and 5 only illustrate the first eleven polarization elements 118 to simplify the drawings) at four equally-spaced consecutive times (t₁<t₂<t₃<t₄). The polarization elements 118 are identified in FIG. 6 according to the azimuthal coordinate φⱼ (j=1, 2, 3, . . . , 20) of the center of each polarization element 118. Thus, in FIG. 6, the horizontal axis corresponds to the position of each of the twenty polarization elements 118 along the dielectric radiator 112 (which extends along a y-axis, as shown in FIGS. 4-5) and the vertical axis shows the voltages Vⱼ that are applied to the twenty polarization elements 118. The four curves show the respective voltages applied to the twenty polarization elements 118 at the four different points in time t₁ through t₄. As can be seen in FIG. 6, over time a sinusoidally varying excitation signal is applied to the polarization elements 118.

In FIG. 6, Vⱼ ∝ cos [ω(t−jΔt)] where Δt is the time difference between the instants at which the oscillatory voltages applied to adjacent polarization elements attain their maximum amplitude. Accordingly, the constant phase difference ωΔt between the oscillations of adjacent polarization elements 118 results in a sinusoidal polarization current wave that propagates to the right through the dielectric radiator 112 with the speed Δl/Δt, where Δl is the distance between the centers of adjacent polarization elements 118. While sinusoidal curves are illustrated in the example of FIG. 6, it will be appreciated that the embodiments of the present invention discussed herein are not limited to sinusoidal curves. In particular, other waveforms may be employed to achieve any desired polarization current wave. Additionally, while a polarization current wave is one type of volume polarization current distribution pattern that may be made to propagate through the dielectric radiator 112, it will be appreciated that embodiments of the present invention are not limited to volume polarization current distribution patterns that are waves that are made to propagate through the dielectric radiator 112.

It will also be appreciated that polarization devices other than a series of upper electrodes 114 and a ground plane 116 may be used to apply an electric field across a portion of the dielectric radiator 112. For example, in other embodiments, the ground plane 116 may be replaced with a plurality of individual lower electrodes which may or may not be connected to ground. Note that herein the term “electrode” is used broadly to encompass the ground plane 116 as well as upper and lower electrodes. In still other embodiments, structures other than electrodes may be used to polarize the dielectric radiator 112. The polarization devices are preferably sized such that a plurality of polarization devices may be located closely adjacent to each other so that, when excited in sequence, the polarization devices apply a stepped approximation of a continuous electric field distribution to the dielectric radiator 112 as shown in the example of FIG. 6 above.

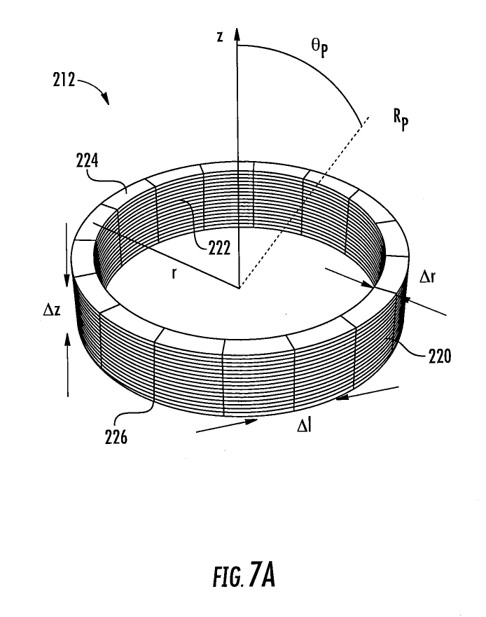

Various embodiments of the present invention will now be discussed in greater detail with respect to FIGS. 7-9.

A first arc-shaped equatorially radiating polarization current antenna 200 according to embodiments of the present invention is illustrated in FIG. 7. The polarization current antenna 200 has a dielectric radiator 212 that extends a full 360 degrees to form a ring. It should be noted that herein a “ring-shaped” or “circular” structure is considered to be an “arc-shaped” structure where the arc is a closed arc that extends for a full 360 degrees.

Referring to FIG. 7, the polarization current antenna 200 includes a dielectric radiator 212, a plurality of upper electrodes 214 and a plurality of lower electrodes 216. The dielectric radiator 212 is arranged in an arc about a vertical axis of rotation z, and extends fully around the axis of rotation z in the example of FIG. 7. FIG. 7A is a schematic perspective view of the dielectric radiator 212 included in the antenna 200 of FIG. 7. As shown in FIG. 7A, the dielectric radiator 212 has an outer surface 220, an inner surface 222, a top surface 224, and a bottom surface 226. The outer surface 220 may comprise the front surface of the polarization current antenna 200 and may be the surface of the polarization current antenna 200 through which electromagnetic radiation is emitted. The upper electrodes 214 may be on the top surface 224 of dielectric radiator 212 and the lower electrodes 216 may be on the bottom surface 226 of dielectric radiator 212. The upper and lower electrodes 214, 216 may be vertically aligned so as to be arranged in pairs. Each pair of an upper electrode 214 and a lower electrode 216 and the portion of the dielectric radiator 212 disposed therebetween forms a respective polarization element 218. The electrodes 214, 216 may be replaced with other polarization devices in other embodiments.

The dielectric radiator 212 in the example of FIG. 7 comprises a continuous dielectric block that is formed in the shape of a ring. As shown in FIGS. 7 and 7A, the dielectric radiator 212 has a mean radius r₀, a thickness Δr, and a height Δz. Each upper electrode 214 has the same angular width around the arc, and the upper electrodes 214 are spaced apart by uniform amounts. In particular, the center of each upper electrode 214 is spaced apart from the centers of adjacent upper electrodes 214 by a constant (arc-length) distance Δl. Likewise, each lower electrode 216 has the same angular width around the arc, and the lower electrodes 216 are spaced apart by uniform amounts so that the center of each lower electrode 216 is spaced apart from the centers of adjacent lower electrodes 216 by the constant distance Δl. While the dielectric radiator 212 is depicted as a continuous block in FIG. 7, it will be appreciated that a plurality of discrete dielectric radiators 212 may be used instead in other embodiments, which may or may not touch one another. As the polarization current wave that is generated when the dielectric radiator 212 is polarized in sequence moves from a first polarization element 218 to a second polarization element 218, it travels in an annular strip with radii r₀+/−½ Δr about the axis of rotation z (note that the mean radius r₀ is measured to the center of the dielectric radiator 212). The direction in which the polarization current antenna 200 emits electromagnetic radiation is controlled by the velocity of the polarization current wave, as will be described in further detail below.

In the ring-shaped polarization current antenna 200 of FIG. 7, the polarization current wave within the dielectric radiator 212 rotates with the angular frequency:

$$ω = \frac{2 π v}{m} \qquad ( 3 )$$

where ν is the frequency of oscillations of the applied voltages (e.g., 2.5 GHz) and m is the length around the ring-shaped dielectric radiator 212 of the polarization current antenna 200 in terms of the number of wavelengths Lₚ of the polarization current wave. Referring again to FIG. 6, the length around the ring-shaped dielectric radiator 212 in terms of the number m of wavelengths Lₚ of the polarization current wave refers to how many wavelengths Lₚ the polarization current wave passes through in passing through the complete arc of the dielectric radiator 212 once. In the example of FIG. 6, the wavelength Lₚ of the polarization current wave corresponds to twenty polarization elements, and hence m is equal to one. If, for example, the polarization current antenna associated with the graph of FIG. 6 instead included sixty polarization elements, then m would be equal to three. Improved performance may be possible in some cases if m is an integer, although embodiments of the present invention are not limited to polarization current antennas for which m is an integer value.

The speed of the polarization current wave (which acts as the source of the electromagnetic radiation emitted by the polarization current antenna 200) has the value u=rω at a radius r within the ring-shaped dielectric radiator 212. The non-spherically decaying electromagnetic radiation (i.e., the electromagnetic radiation that does not decay with distance d from the source according to the inverse square law 1/d²) that is generated by this polarization current wave at the radius r within the dielectric radiator 212 is emitted at the polar angles:

θ_{P}=arcsin(c/u) and θ_{P}=π−arcsin(c/u) (4)

above and below the equatorial plane θ_{P}=π/2, where θ_{P} denotes the angle between the axis of rotation z and the direction at which the electromagnetic radiation is emitted and c is the speed of light in vacuum. The emitted waves constructively interfere to form cusps along the above two values of θ_{P} because the volume elements of the distribution pattern of the polarization current that move with the superluminal speed u approach a far-field observer located at these values of θ_{P} with the speed of light and zero acceleration at the retarded time.

Pursuant to embodiments of the present invention, the electric field may be applied to the arc-shaped dielectric radiator 212 in such a way that u equals c within the radial thickness Δr of the arc-shaped dielectric radiator 212. In some embodiments, the electric field is applied to the dielectric radiator 212 such that u equals c at the center of the dielectric radiator 212. This results in the emission of electromagnetic radiation into the plane of rotation θ_{P}=π/2. Note that when u equals c at the center of the dielectric radiator 212, then the polarization current wave will move subluminally at the inner radius of the arc-shaped dielectric radiator 212 (i.e., at a speed that is less than the speed of light) while the polarization current wave will move superluminally at the outer radius of the arc-shaped dielectric radiator 212 (i.e., at a speed that is faster than the speed of light).

There is a strong beam of electromagnetic radiation whose angular width in a direction that is normal to the plane of rotation is given by:

Δθ_{P}=arctan(Δz/R_{P}) (5)

where Δz is the thickness of the arc-shaped dielectric radiator 212 along the direction parallel to the axis of rotation (i.e., perpendicular to the circle defined by the radius of the arc-shaped dielectric radiator 212) and R_{P} is the distance of the observation point P from the center of the arc-shaped dielectric radiator 212. The intensity of a portion of the emitted electromagnetic radiation diminishes as 1/R_{P}^{α} with 1<α<2 as the distance R_{P} from the antenna 200 increases. The direction of emission of the electromagnetic radiation within the equatorial plane θ_{P}=π/2 is everywhere tangent to the arc-shaped dielectric radiator 212. The radiation will emit in a full 360 degree circle in the example of FIG. 7 as the dielectric radiator 212 extends through a full 360 degrees.

The polarization current antenna 200 may be designed so that the electric field that is applied to the arc-shaped dielectric radiator 212 will generate a polarization current wave that has a velocity u that equals c within the radial thickness Δr of the dielectric radiator 212 for a given frequency ν of an input signal by selecting the mean radius r₀ of the dielectric radiator, the number of polarization elements N and the time difference Δt between the instants at which the input signals are applied to adjacent polarization elements 218 attain their maximum amplitudes. In other words, an antenna designer may select the following four parameters for the polarization current antenna having a circular dielectric radiator:
N is the total number of polarization elements included in the antenna;
r₀ is the mean radius of the circular dielectric radiator;
Δt=the time difference between the instants at which the input signals applied to adjacent polarization elements attain maximum amplitude; and
ν=the frequency of the input signal (i.e., the signal to be transmitted) that is applied to the polarization elements.

Based on the above parameters, the following parameters of the polarization current antenna 200 may be determined:
Δl=the center-to-center distance between adjacent polarization elements=(2π)r₀/N;
ΔΦ=360*ν*Δt=phase difference between the oscillations of adjacent polarization elements in degrees;
m=the number of wavelengths of the polarization current wave that fit around the circumference of the circular dielectric radiator=ΔΦ*N/360; and
(1/c)*(Δl/Δt)=(360*ν*Δl)/(c*ΔΦ)=propagation speed of the polarization current wave in units of the speed of light in vacuo (c).

Thus, the values of N, r₀ and Δt may be selected for a given ν in order to design the polarization current antenna so that it will generate a polarization current wave that has a desired propagation speed through the circular dielectric radiator 212 such as, for example, a propagation speed equal to the speed of light in vacuo (c).

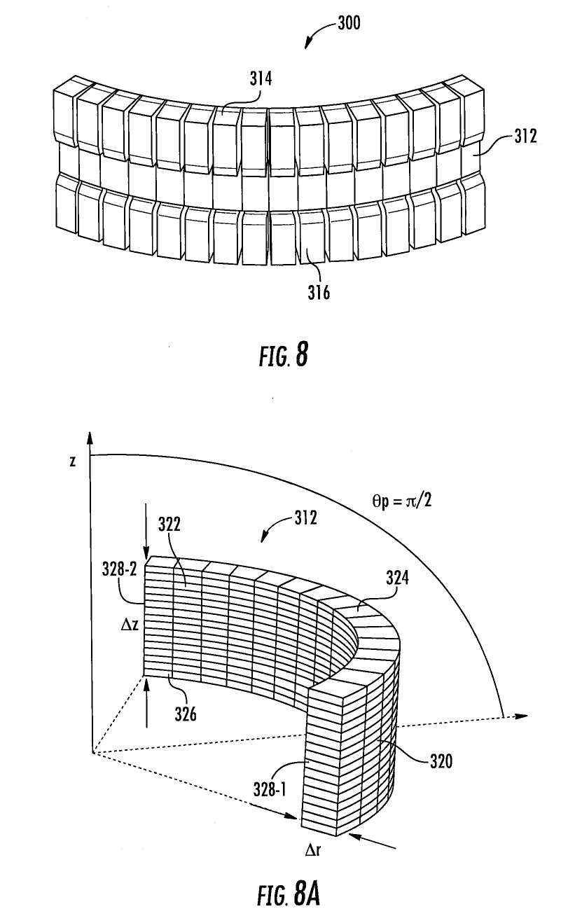

A second arc-shaped polarization current antenna 300 according to embodiments of the present invention is illustrated in FIG. 8. The polarization current antenna 300 includes a dielectric radiator 312 that extends in an arc of φ=120 degrees, or more generally, of 0<φ<360 degrees. Thus, the polarization current antenna 300 differs from the polarization current antenna 200 of FIGS. 7-7A in that the polarization current antenna 300 does not extend through a full circle. The polarization current antenna 300 further includes a plurality of upper electrodes 314 and a plurality of lower electrodes 316. The dielectric radiator 312 is arranged in an arc about a vertical axis of rotation z, but in this case extends around only about 120 degrees of the axis of rotation z. FIG. 8A is a schematic perspective view of the dielectric radiator 312 included in the antenna 300 of FIG. 8. As shown in FIG. 8A, the dielectric radiator 312 has an outer surface 320, an inner surface 322, a top surface 324, a bottom surface 326 and a pair of end surfaces 328. Electromagnetic radiation is emitted through the outer surface 320. The upper and lower electrodes 314, 316 may be vertically aligned so as to be arranged in pairs to form respective polarization elements 318. The electrodes 314, 316 may be replaced with other polarization devices in other embodiments. The dielectric radiator 312 comprises a continuous dielectric block again having a mean radius r₀, a thickness Δr, and a height Δz. Each upper electrode 314 and each lower electrode 316 have the same angular width and are spaced apart by uniform amounts. The centers of each upper and lower electrode 314, 316 are spaced apart from the centers of respective adjacent upper and lower electrodes 314, 316 by a constant distance Δl. As the polarization current wave moves from polarization element 318 to polarization element 318 it travels in an annular strip with radii r₀++/−½Δr about the axis of rotation z. As with the polarization current antenna 200 of FIG. 7 discussed above, the direction in which electromagnetic radiation is emitted from the polarization current antenna 300 is controlled by the velocity of the polarization current wave.

In the arc-shaped polarization current antenna 300 of FIG. 8, the polarization current wave rotates within the dielectric radiator 312 with the angular frequency shown by Equation (3) above and the speed of the polarization current wave has the value u=rω at a radius r within the arc-shaped dielectric radiator 312. The non-spherically decaying electromagnetic radiation generated by the portion of the polarization current wave that rotates through the dielectric radiator 312 at the radius r is emitted at the polar angles θ_{P} given by Equation (4) above.

As with the polarization current antenna of FIG. 7 discussed above, the electric field may be applied to the arc-shaped dielectric radiator 312 in such a way that u equals c within the radial thickness Δr of the arc-shaped dielectric radiator 312 so that the electromagnetic radiation is emitted into the plane of rotation θ_{P}=π/2. The beamwidth of the stronger portion of the non-spherically decaying electromagnetic radiation that propagates into the plane of rotation is given by Equation (5) above. The direction of emission of the electromagnetic radiation within the equatorial plane θ_{P}=π/2 is everywhere tangent to the arc-shaped dielectric radiator 312. Referring to FIG. 9, it can be seen that the azimuthal beamwidth Δφ_{P} of the emitted electromagnetic radiation has the same value as the angle subtended by the arc-shaped dielectric radiator 312. Thus, in the present case, the azimuth beamwidth will be about 120 degrees since the arc-shaped dielectric radiator 312 extends through an arc of about 120 degrees.

Pursuant to some embodiments of the present invention, the polarization current antennas of FIGS. 7-8 may have the following characteristics:
The polarization current antennas 200, 300 may be designed so that the velocity of the polarization current wave is equal to the speed of light in vacuum within at least a portion of the dielectric radiator 212, 312 (for example, the polarization current wave may travel at a speed that is less than or equal to the speed of light in vacuum along an inner radius of the dielectric radiator and may travel at a speed that is greater than the speed of light along an outer radius of the dielectric radiator);
The polarization current antennas 200, 300 may include at least five polarization elements per wavelength of the polarization current wave; and
The arc defined by the arc-shaped dielectric radiator 212, 312 extends over a distance of at least 2 wavelengths of the polarization current wave (i.e., m≧2), and, in some embodiments, the distance that the arc extends may be substantially equal to an integral multiple of such wavelengths.

TABLE 1 below sets forth various example embodiments of arc-shaped polarization current antennas according to embodiments of the present invention that may be similar or identical to the polarization current antenna 300 of FIG. 8.

TABLE 1

| | | | | | | Inner | Mean | Mean Speed |
|---|---|---|---|---|---|---|---|---|
| Frequency | ΔΦ | Δl | | Angle of Arc | | Radius | Radius | (in units |
| (GHz) | (deg) | (cm) | m | φ (deg) | N | (cm) | r₀ (cm) | of c) |
| 2.5 | 27.7 | 1.015 | 10 | 360 | 130 | 19 | 21 | 1.1 |
| 2.5 | 13.85 | 0.507 | 5 | 360 | 130 | 10.4 | 11.5 | 1.1 |
| 1.25 | 13.85 | 1.015 | 5 | 360 | 130 | 19 | 21 | 1.1 |
| 5 | 27.7 | 0.507 | 10 | 360 | 130 | 10.4 | 11.5 | 1.1 |
| 2 | 22.5 | 1 | 5 | 360 | 80 | 11.9 | 12.7 | 1.066 |
| 1 | 11.25 | 1 | 5 | 120 | 160 | 71.6 | 76.4 | 1.066 |
| 2 | 11.25 | 0.5 | 5 | 120 | 160 | 35.8 | 38.2 | 1.066 |
| 1.75 | 20 | 1 | 10 | 120 | 180 | 81.8 | 85.9 | 1.05 |
| 2.5 | 30 | 1 | 20 | 120 | 240 | 113 | 114.6 | 1 |

The polarization current antennas according to some embodiments of the present invention may have the electrodes disposed adjacent the top and bottom surfaces of the arc-shaped dielectric radiator. The top and bottom electrodes may lie in first and second parallel planes. The first plane defined by the upper electrodes (e.g., electrodes 314) and the second plane defined by the lower electrodes (e.g., electrodes 316) are not only parallel to each other, but also are parallel to a third plane that is parallel to the direction of propagation of the polarization current wave. In contrast, some known circular polarization current antennas position the electrodes on the inner and outer surfaces of the ring-shaped dielectric radiator. In these known polarization current antennas, the direction of a vector perpendicular to the exposed face of the dielectric radiator is parallel to the axis of rotation of the displacement current.

Referring again to FIG. 8, the polarization current antenna 300 only extends through an angle φ of about 120 degrees. The polarization elements 318 thereof are excited in sequence starting, for example, with the first polarization element on a first end 328-1 of the polarization current antenna 300. Each polarization element 318 is excited in turn with a constant time delay interval. Eventually the last polarization element 318 on the second end 328-2 of the polarization current antenna 300 will be reached. When this occurs, the first polarization element 318 is then excited at the constant delay interval in turn as if it were at the next polarization element 318 in sequence.

The polarization current antennas according to embodiments of the present invention may include a feed network that is used to energize the polarization devices of the polarization elements progressively with a constant time delay interval (i.e., the time period between when a first polarization element is energized and a second, adjacent polarization element is energized is constant across all polarization elements). When such a feed network is used, the angular speed of the polarization current wave will be constant. However, even though the speed of the polarization current wave is constant, by virtue of the geometry of the antenna, when such a feed network is applied to a curved or circular array of polarization elements, the rotating volume elements of the polarization current wave are centripetally accelerated. The polarization elements 318 may be continuously excited in this fashion.

Accordingly, pursuant to embodiments of the present invention, polarization current antennas having arc-shaped dielectric radiators are provided that may be designed to emit electromagnetic radiation equatorially or near equatorially. In some embodiments, the polarization current antennas may be designed according to the following parameters:
φ=the angular extent of the arc-shaped dielectric radiator in degrees;
Δl=the center-to-center distance between adjacent polarization elements;
Δt=the time difference between the instants at which the input signal applied to adjacent polarization elements attains maximum amplitude;
ν=the frequency of the input signal (i.e., the signal to be transmitted) that is applied to the polarization elements;
ΔΦ=360*ν*Δt=phase difference between the oscillations of adjacent polarization elements in degrees;
(1/c)*(Δl/Δt)=(360*ν*Δl)/(c*ΔΦ)=propagation speed of the polarization current wave in units of the speed of light in vacuo (c);
m=the number of wavelengths of the polarization current wave that fit around the circumference of the arc-shaped dielectric radiator;
N=360*m/ΔΦ=the total number of polarization elements in the antenna; and
r₀=360*N*Δl/2π*φ=the mean radius of the arc-shaped dielectric radiator.

In some embodiments, the polarization current antennas may be configured so that the polarization current wave travels at the speed of between c and 1.02*c within a portion of the dielectric radiator, where c is the speed of light in vacuo (c). This may result in equatorial or near-equatorial emission. In some embodiments, the polarization current antennas may be configured so that the polarization current wave travels at the speed of light within at least a portion of the dielectric radiator in order to, for example, cause the polarization current antenna to emit radiation equatorially.

Enhanced performance may be achieved when the polarization current antennas described herein are configured for equatorial emission or near equatorial emission. This is because an additional mechanism of focusing comes into play if there are volume elements of the distribution pattern of the polarization current whose speeds u are close to the speed of light c. As u approaches the value c, the two polar angles appearing in Equation (4) both approach the value 90 degrees, i.e., both approach the equatorial plane. As a result, an observer whose z coordinate is small enough to match the z coordinates of the source elements that approach the observer with the speed of light and zero acceleration receives waves that are further focused by the coalescence of the two arms of the cusps described in Equation (4). A higher degree of focusing of the received waves in turn implies an enhanced intensity for the resulting radiation.

A computational program such as Mathematica may be used to solve Maxwell's equations to determine the radiation field that is generated by an arc-shaped polarization current antenna according to embodiments of the present invention. Maxwell's equations were solved to determine the radiation field emitted by a ring-shaped polarization current antenna.

In performing the above-described computational analysis, it was assumed that the polarization current antenna had the general design of the polarization current antenna 200 that is described above with reference to FIGS. 7 and 7A. Accordingly, the description below will use the reference numerals shown in FIGS. 7 and 7A to describe this polarization current antenna 200. It will be appreciated that minor variations may exist between the antenna 200 pictured in FIGS. 7 and 7A and the exact antenna design used in the computation analysis such as, for example, the number of upper and lower electrodes 214, 216.

The polarization current antenna 200 that was modelled in the computational analysis had a ring-shaped dielectric radiator 212 with the following parameters:

Average radius (r₀)=21 cm;

Radial width (Δr)=3.8 cm;

Height (Δz)=3.8 cm.

The (arc-length) distance (Δl) between the centers of adjacent upper electrodes 214 was assumed to be Δl=1.015 cm. The circumference of the above-described antenna 200 is 2πr=131.945 cm. Since each upper electrode 214 extends for a distance of 1.015 cm, the antenna 200 has 130 electrode pairs.

The polarization current flows in the dielectric radiator 212 in a direction that is parallel to the axis of rotation z and was assumed to have an oscillation frequency of ν=2.5 GHz. The density of the polarization current was assumed to be 2.5 amps/m². The resultant polarization current wave that would be generated in the dielectric radiator 212 of antenna 200 has a sinusoidal shape, and this polarization current wave travels through ten wavelengths when travelling once around the full circumference of the dielectric radiator 212 (i.e., m=10). The polarization current wave rotates with an angular frequency of ω=1.57×10⁹ radians/second. The above-described physical parameters for the dielectric radiator 212, the electrodes 214 and the oscillation frequency ν for the polarization current were selected so that the speed u=rω of the polarization current wave is equal to the speed of light in a vacuum (c) at the inner radius of the dielectric radiator 212 and the speed of the polarization current wave is 1.2*c at the outer radius of the dielectric radiator 212. These speeds u may be experimentally realized in the above-described polarization current antenna 200 by setting the phase difference ΔΦ between the oscillations of the voltages on adjacent pairs of electrodes 214, 216 equal to 27.7°.

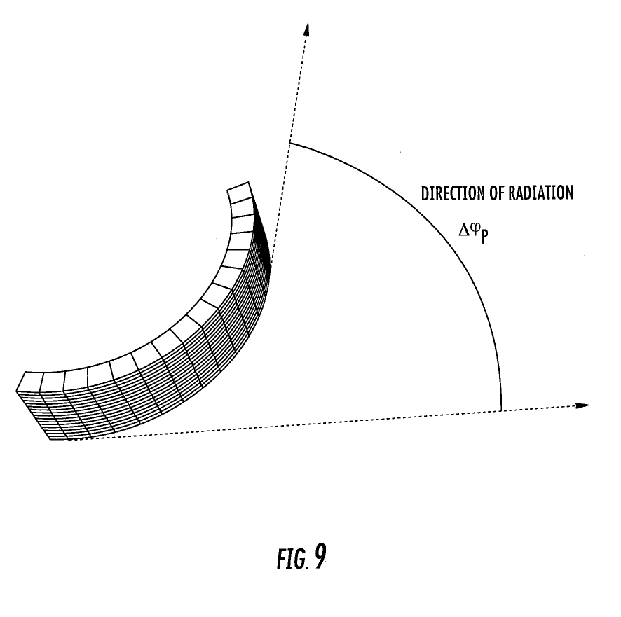

The time-averaged value of the component of the Poynting vector along the radiation direction was solved for the polarization current antenna 200 having the above-described parameters. The time-averaged value of the component of the Poynting vector along the radiation direction represents the power emitted by the polarization current antenna 200 that propagates across a unit area normal to the radiation direction at a given observation point P. FIG. 10 is a graph of the time-averaged value of the component of the Poynting vector along the radiation direction divided by the average value of the power that propagates across a sphere of radius R_{P}=10 c/ω per unit solid angle as a function of the polar coordinate θ_{P} of the observation point P (i.e., the location where the power of the emitted radiation is measured), where R_{P} is the spherical polar coordinate of the observation point P. The parameter c/ω corresponds to the radius of the light cylinder for the polarization current antenna 200. A light cylinder refers to the cylinder on which the linear speed rω of a rotational motion equals the speed of light c, and the radius thereof may be a convenient unit for expressing the distance to selected observation points P when evaluating the performance of a polarization current antenna. For the polarization current antenna 200 having the above-described parameters, the light cylinder has a radius of c/ω=19.1 cm. Thus, FIG. 10 shows the directive gain of the antenna 200 at various observation points P that are each at a distance of 1.91 meters from the antenna 200, as a function of the polar angle θ_{P} of the observation point P. Note that a logarithmic unit of measurement is used along the vertical axis in FIG. 10 so that changes in the plotted quantity (i.e., the time-averaged value of the component of the normalized Poynting vector along the radiation direction) are shown in decibels.

In FIG. 10, the curve formed by the data points (labelled curve 300) represents the received power per unit area of the electromagnetic radiation emitted by the polarization current antenna 200. As should be clear from the discussion above, curve 300 includes received power that is generated by both (1) source elements of antenna 200 (i.e., portions of the polarization current wave) that have a velocity component along the direction the electromagnetic radiation travels to the observation point P that is less than the speed of light in vacuo (c) and by (2) source elements of antenna 200 that have a velocity component along the direction the electromagnetic radiation travels to the observation point P that is greater than or equal to the speed of light in vacuo (c). Note that FIG. 10 shows only half of the radiation distribution, since the radiation pattern is symmetric with respect to the equatorial plane θ_{P}=90°. It therefore will be appreciated that, for polar angles of 90<θ_{P}≦180°, the radiation distribution will be the mirror image with respect to the equatorial plane θ_{P}=90° of the radiation distribution shown in FIG. 10.

The electromagnetic radiation emitted by the polarization current antenna 200 that is generated by source elements that have a velocity component along the direction the electromagnetic radiation travels to the observation point P that is less than the speed of light in vacuo (c) represents the power per unit area of the conventional electromagnetic radiation emitted by polarization current antenna 200 (i.e., radiation that decays with distance d from the source according to the inverse square law, 1/d²). As shown in FIG. 10, a sharp increase in the power per unit area of the emitted electromagnetic radiation occurs at the polar angle of θ_{P}=56.4°. As is explained in more detail below, this sharp increase occurs because at polar angles of 56.4°≦θ_{P}≦123.6° there are source elements that have a velocity component along the direction the electromagnetic radiation travels to the observation point P that is greater than or equal to the speed of light in vacuo (c). The electromagnetic radiation emitted by such source elements is referred to herein as “non-spherically decaying electromagnetic radiation” as it has different properties from conventional radiation including the fact that it does not decay according to the inverse square law as does conventional electromagnetic radiation.

As shown in FIG. 10, the non-spherically decaying electromagnetic radiation is only emitted at polar angles of 123.6°≧θ_{P}≧56.4° given the particular design (described above) of the polarization current antenna 200 and the oscillation frequency of the polarization current. This is consistent with Equation (4) above, which shows that the non-spherically decaying electromagnetic radiation from each volume element of the antenna 200 is emitted at the polar angles:

θ_{P}=arcsin(c/u) and θ_{P}=180°−arcsin(c/u)

above and below the equatorial plane θ_{P}=π/2, where c is the speed of light in vacuo and u is the speed of the volume element in question of the polarization current wave in units of the speed of light in vacuo. Here, the maximum speed u of the polarization current wave occurs at the outer radius of the dielectric radiator 212, where the speed of the polarization current wave is uₘₐₓ=1.2*c. The minimum speed of the polarization current wave, which occurs at the inner radius of the dielectric radiator 212, is uₘᵢₙ=c. Thus, filling these speeds u into Equation (4) it can be seen that the non-spherically decaying electromagnetic radiation is emitted between the polar angles of 56.4°≦θ_{P}≦123.6°.

As the above discussion makes clear, the angular elevation beamwidth of polarization antenna 200 will be a function of the speed of the polarization current wave generated in the arc-shaped dielectric radiator, where angular elevation beamwidth refers to the range of polar angles into which the non-spherically decaying electromagnetic radiation is emitted. In the example above, the non-spherically decaying electromagnetic radiation is emitted into polar angles in the range of 56.4°≦θ_{P}≦123.6°, which corresponds to an angular elevation beamwidth of 67.2°. So long as the polarization current wave has a speed equal to the speed of light in vacuo at some point within the dielectric radiator 212, then the angular elevation beamwidth of the of non-spherically decaying electromagnetic radiation emitted by the polarization current antenna 200 will be equal to 180°−2*arcsin(c/uₘₐₓ), where c is the speed of light in vacuo and uₘₐₓ is the speed of the polarization current wave at the outer radius of the dielectric radiator 212.

Based on the relationship between the speed of the polarization current wave and the angular elevation beamwidth, a method of operating the above-described polarization current antennas according to embodiments of the present invention is to generate a polarization current wave in the arc-shaped dielectric radiator thereof that has a pre-selected speed at the outer radius of the arc-shaped dielectric radiator that is selected so that the beam of non-spherically decaying electromagnetic radiation that is generated by the polarization current wave has a pre-selected angular elevation beamwidth. In example embodiments for which the speed uₘᵢₙ of the polarization current wave at the inner radius of the arc-shaped dielectric radiator is smaller or equal to the speed of light in vacuo, the pre-selected speed uₘₐₓ of the polarization current wave at the outer radius of the arc-shaped dielectric radiator may be between the speed of light in vacuo and 1.2 times the speed of light in vacuo, which results in an angular elevation beamwidth of 67.2° or less. In another example embodiment, the pre-selected speed uₘₐₓ of the polarization current wave at the outer radius of the arc-shaped dielectric radiator may be between the speed of light in vacuo and 1.02 times the speed of light in vacuo, which results in an angular elevation beamwidth of 22.8° or less. Any appropriate speed may be selected to achieve a desired angular elevation beamwidth.

Reference is now made to FIG. 10A, which is a graph comparing the radiation distribution pattern of FIG. 10 (curve 300) to the radiation distribution pattern of a stationary source (curve 350). In particular, curve 350 shows the distribution of the time-averaged radial component of normalized Poynting vector, as a function of the polar coordinate θ_{P} of observation points P that are at a distance \hat{R}_{P}=10, for emission from a polarization current that is identical to the polarization current used to generate FIG. 10, except that the polarization current used to generate curve 350 has a stationary distribution pattern (i.e., it does not rotate around the dielectric radiator). In generating curve 350 it was assumed that the polarization current had the same sinusoidal distribution pattern, the same current density and the same oscillation frequency as the polarization current used to generate curve 300, and that the polarization current was generated in a dielectric radiator having the same dimensions as the dielectric radiator 212 discussed above. Moreover, the normalization factor used in FIG. 10A is the same as that in FIG. 10: namely the average value of the power arising from the rotating source that propagates across a sphere of radius \hat{R}_{P}=10 per unit solid angle. The emission from the stationary source decays spherically as predicted by the inverse square law.

As can also be seen from FIG. 10A, the power of the non-spherically decaying electromagnetic radiation (curve 300) is more than 18 dB greater than the power of the conventional electromagnetic radiation (curve 350) across the full range of polar angles θ_{P} where the non-spherically decaying electromagnetic radiation is emitted. Thus, even at very small distances (here the magnitude of the electromagnetic radiation is measured at an observation point P that is less than 2 meters from the polarization current antenna 200), the magnitude of the non-spherically decaying electromagnetic radiation exceeds the magnitude of the conventional radiation by more than a factor of sixty at all polar angles at which the non-spherically decaying electromagnetic radiation is emitted. Moreover, as can also be seen from FIG. 10A, the degree to which the non-spherically decaying electromagnetic radiation exceeds the conventional electromagnetic radiation increases dramatically at polar angles θ_{P} that are close to 90°. In fact, in the example, of FIG. 10A, the non-spherically decaying electromagnetic radiation (curve 300) exceeds the conventional electromagnetic radiation (curve 350) by a factor of more than 200 for an observation point P at the polar angle of θ_{P}=90°.

The rapid change in the intensity of the total electromagnetic radiation that occurs for observation points P at polar angles of θ_{P}≧56.4° reflects the penetration of the cusps associated with these observation points P into the source distribution across its outer boundary, where the outer boundary is the outermost radius r_{U} of the dielectric radiator 212. The cusp is the locus of source elements at which (1) the component of the velocity of the polarization current wave along the direction of the electromagnetic radiation (i.e., along the line from the source element to the selected observation point P) equals the speed of light in vacuo and (2) the component of acceleration of the polarization current wave along the direction of the electromagnetic radiation equals zero. In other words, when the observation point P is located at a polar angle of θ_{P}=56.4 degrees, there is a volume element of the ring in the polarization current wave travelling through the dielectric radiator 212 at the speed of uₘₐₓ=1.2*c (i.e., the portion of the polarization current wave at the outer radius r_{U} of the dielectric radiator 212) that will have a velocity component in the direction of the observation point P that is equal to the speed of light in vacuo and an acceleration vector that is perpendicular to the direction of the line from its retarded position to the observation point P. Consequently, that particular source element on the portion of the polarization current wave that is travelling through the outer radius r_{U} of dielectric radiator 212 will emit non-spherically decaying electromagnetic radiation in the direction of the observation point P. As the polar angle θ_{P} between the axis of rotation z of antenna 200 and the observation point P increases beyond 56.4°, portions of the polarization current wave in the dielectric radiator 212 that lie to the right of the cusp in FIG. 11 will have a velocity component in the direction of the observation point P that is greater than or equal to the speed of light in vacuo, and hence these additional portions of the dielectric radiator will emit non-spherically decaying electromagnetic radiation in the direction of the selected observation point P. This effect is illustrated graphically in FIG. 11.

In particular, FIG. 11 is a graph that illustrates the location of a cross-section of the dielectric radiator 212 (labelled “Source” in FIG. 11) of the polarization current antenna 200 by a meridional plane. The dielectric radiator 212 has an inner radius r_{L} and an outer radius r_{U}. As described above, the polarization current wave travels within the dielectric radiator 212 with a fixed angular velocity ω [its linear velocity rω varies linearly between r_{L}ω and r_{U}ω (c and 1.2*c in the selected example) depending upon the radial location of the polarization current wave within the dielectric radiator 212]. The relative velocity of the polarization current wave with respect to a selected observation point P will vary based upon the polar angle θ_{P} between the selected observation point P and the polarization current antenna 200. The curve labelled 400 in FIG. 11 is the projection of the cusp associated with a selected observation point P onto the meridional plane of FIG. 11. In the graph of FIG. 11, \hat{r}=rω/c and \hat{z}=zω/c are cylindrical polar coordinates based on the axis of rotation in units of c/ω, and thus the coordinates in FIG. 11 represent both speed (in units of c) and position (in units of c/ω). Whether the cusp 400 will intersect the dielectric radiator 212 (the source distribution), as shown in FIG. 11, or alternatively lies to the left or the right of the dielectric radiator 212, is dictated by the polar coordinate θ_{P} of the selected observation point P. In FIG. 11, the selected observation point was placed close to the source (dielectric radiator 212), namely at \hat{r}_{P}=\hat{z}_{P}=3 so that the point of intersection of the cusp 400 with the light cylinder (\hat{r}=1) falls within the figure. Note that the \hat{z} coordinate of the point of intersection of the cusp with the light cylinder (shown by the green dashed vertical line in FIG. 11) has the same value as the \hat{z} coordinate \hat{z}_{P} of the observation point P.

The portion of the polarization current wave that at the observation time occupies the portion of the dielectric radiator 212 that lies to the right of the cusp 400 in FIG. 11 will have a velocity along the radiation direction to the observation point P that exceeds the speed of light in vacuo, thus generating non-spherically decaying electromagnetic radiation. The portion of the polarization current wave that at the observation time occupies the portion of the dielectric radiator 212 that lies to the left of the cusp 400 in FIG. 11 will have a velocity along the radiation direction to the observation point P that is less than the speed of light in vacuo, and hence will only generate conventional electromagnetic radiation. The portion of the polarization current wave that travels through the portion of the dielectric radiator 212 that lies along the cusp 400 in FIG. 11 will have a velocity along the radiation direction to the observation point P that equals the speed of light in vacuo, with zero acceleration, and hence will emit waves of electromagnetic radiation that interfere constructively at the observation point P.

Referring again to FIG. 10, the antenna only emits conventional radiation in the direction of observation points P that lie at polar angles θ_{P} of less than 56.4°, resulting in the relatively lower values for the radial component of the Poynting vector for observation points P in these locations. However, for observation points P that lie at polar angles θ_{P}≧56.4°, the cusps 400 are such that they penetrate the dielectric radiator 212 in the manner shown in FIG. 11, and hence a rapid increase in the intensity of the received electromagnetic radiation at the observation point P is observed, as shown in FIG. 10. As it is only those source elements that lie along (or very close to) the cusp 400 that exhibit the constructive interference, penetration of the cusp 400 farther into the dielectric radiator 212 only provides a limited additional increase in the radiation intensity, as is also shown in FIG. 10.

It should be noted that FIG. 11 does not represent the above-described polarization current antenna 200 that was modelled to generate the results shown in FIG. 10, as the polarization current antenna 200 used in the modelling was designed to generate a polarization current wave having a speed equal to the speed of light in vacuo at the inner radius r_{L} of the dielectric radiator 212 thereof. The graph of FIG. 11 represents a more general case where the speed of the polarization current wave exceeds the speed of light in vacuo throughout the entire cross-section of the dielectric radiator.

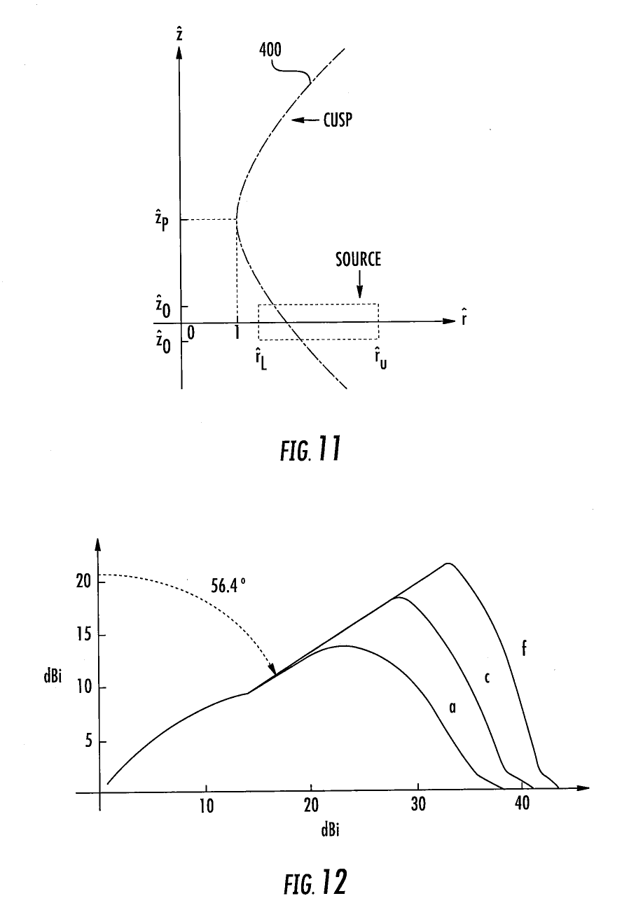

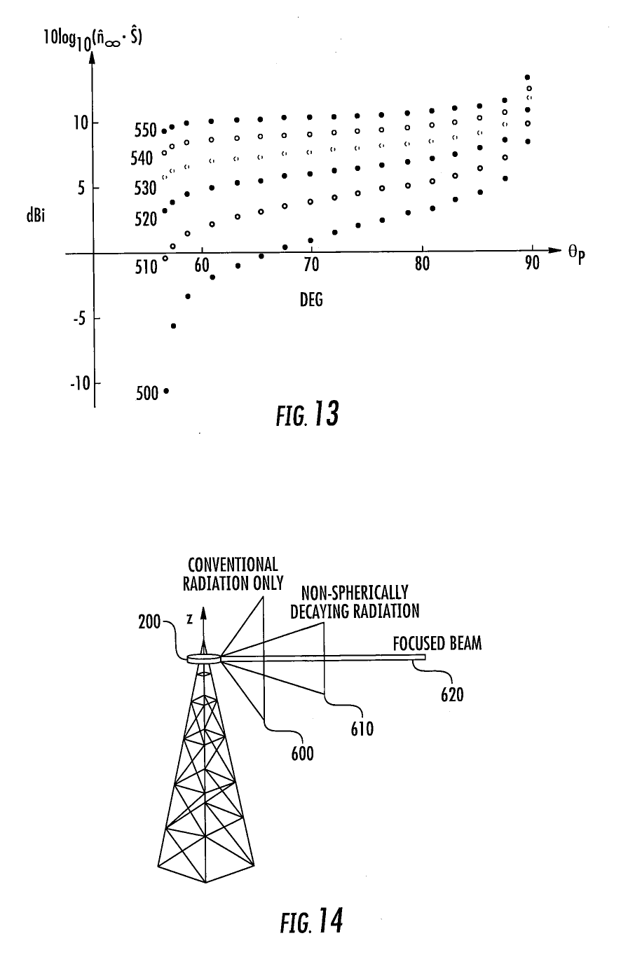

The integral of the radial component of the time-averaged Poynting vector over a sphere having a radius of \hat{R}_{P}=10 for the emission of curve 300 in FIG. 10A is about 9.9 Watts. This integral represents the total power emitted by the polarization current antenna 200 that propagates across a sphere of radius \hat{R}_{P}=10 when operated in the manner described above to generate the emission shown in FIG. 10. In contrast, the integral of the radial component of the time-averaged Poynting vector over the same sphere for the emission of curve 350 in FIG. 10A, which represents the corresponding total power emitted by a polarization current antenna that is identical to the polarization current antenna 200 except that it is operated to have a stationary source, is 0.11 Watts. This shows that a superluminal source is a more efficient radiator by a factor of 90 (i.e., more than 19 dB) than its stationary counterpart. Moreover, FIGS. 10 and 13 shows that the polarization current antenna when operated in the manner described above has a directive gain that exceeds 8 dBi at a distance of 1.91 meters (\hat{R}_{P}=10) and 13 dBi at a distance of 1.91*10⁵ meters (\hat{R}_{P}=10⁶). It will be appreciated that since the electromagnetic radiation emitted by the polarization current antennas according to embodiments of the present invention does not decay spherically with distance, the gain of these antennas will be a function of distance.

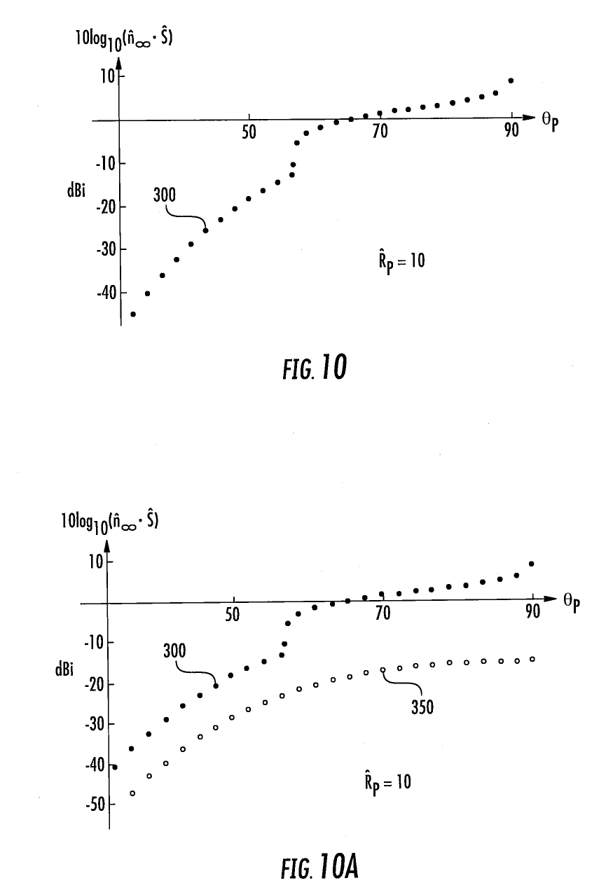

Curve α of FIG. 12 is another representation of the data regarding the intensity of the electromagnetic radiation emitted by the polarization current antenna 200 as a function of the polar coordinate of the observation point P that was obtained through the above-described modelling. In particular, curve a of FIG. 12 illustrates the same data shown in curve 300 of FIG. 10, but FIG. 12 plots this data in a polar coordinate system. In FIG. 12 the data has been normalized by adding 30 dB to all data points so that the radial coordinates of the points in the graph of FIG. 12 have positive values across a sufficiently wide range of angles. The three dimensional radiation pattern for the polarization current antenna 200 at \hat{R}_{P}=10 may be obtained from curve a of FIG. 12 by adding the reflection of curve a shown in FIG. 12 across the equatorial plane (the horizontal axis) and then rotating the plotted data about the z-axis. Curves c and f of FIG. 12 show the counterparts of curve a of this figure at \hat{R}_{P}=10³ and \hat{R}_{P}=10⁶ respectively, i.e., plot the data shown in curves c and f of FIG. 13 in a polar coordinate system. FIG. 12 plots the radiation pattern for the polarization current antenna 200 in a more traditional form.

FIG. 15 is logarithmic plot of the radial component of the normalized Poynting vector versus the normalized distance along the generating line of a cone inside the solid angle where the radiation decays non-spherically. In the example of FIG. 15, the plotted generating line is for the cone corresponding to θ_{P}=60.9°. The points shown in FIG. 15 are extracted from FIG. 12. The best fit to these points has a slowly varying slope of −1.54. Thus, FIG. 15 illustrates that the decay rate of the radial component of the Poynting vector along the direction θ_{P}=60.9° is given by \hat{R}_{P}^{-1.54} (instead of \hat{R}_{P}⁻²) over the range \hat{R}_{P}=10 to \hat{R}_{P}=10⁶. This decay rate itself slowly changes with distance. The plot of FIG. 15 is based on the polarization current antenna 200 that has the parameters listed above that were used in the computational modelling analysis.

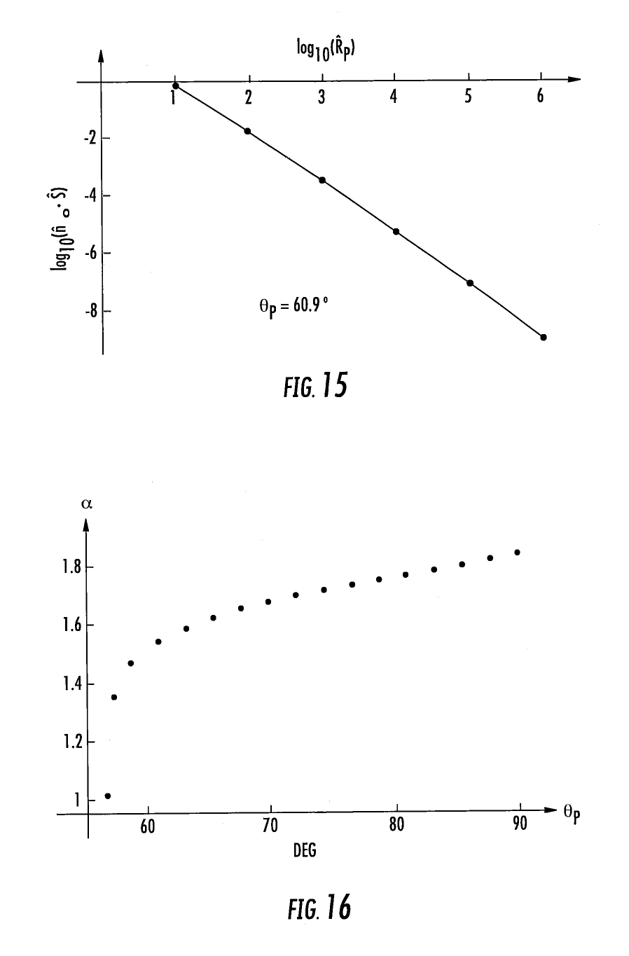

FIG. 16 is graph of the exponent α of the distance dependence \hat{R}_{P}^{-α} of the radial component Poynting vector over the range \hat{R}_{P}=10 to \hat{R}_{P}=10⁶ as a function of the polar angle θ_{P} for values of θ_{P} in the range 56.4<θ_{P}≦90°. The plot of FIG. 16 was obtained by applying the procedure discussed above with reference to FIG. 15 to the entire set of computed points shown in FIG. 12. The plot of FIG. 16 is also based on the polarization current antenna 200 that has the parameters listed above that were used in the computational modelling analysis.

The conventional radiation that is emitted by the polarization current antenna 200 has an angular distribution that is independent of the distance of the observation point P from the polarization current antenna 200. In other words, while the power density of the conventional radiation emitted by polarization current antenna 200 decays with distance d from the source according to the inverse square law, 1/d², the angular distribution of this conventional radiation remains constant. In contrast, the non-spherically decaying electromagnetic radiation, which is emitted into the region 56.4°≦θ_{P}≦90° (focusing solely on observation points above the equatorial plane) has a dependence on θ_{P} that varies with the distance of the observation point P from the polarization current antenna 200. This is illustrated graphically in FIG. 13.

In particular, FIG. 13 is a graph showing the radial component of the time-averaged Poynting vector divided by the average power that propagates across a sphere of radius \hat{R}_{P}=10 per unit solid angle as a function of the polar coordinate θ_{P} of the observation point P for observation points P at six different distances from the polarization current antenna 200. In FIG. 13, the results are only shown for observations points P at polar angles of 56.4°≦θ_{P}≦90° degrees in order to provide better resolution in the figure. The six curves 500, 510, 520, 530, 540, 550 shown in FIG. 13 correspond to observation points P at distances of 10, 100, 1,000, 10,000, 100,000 and 1,000,000 light cylinder radii from the polarization current antenna 200, respectively. This corresponds to physical distances of 1.91 meters (curve 500), 19.1 meters (curve 510), 191 meters (curve 520), 1.91 km (curve 530), 19.1 km (curve 540) and 191 km (curve 550). In FIG. 13, curves 510, 520, 530, 540, 550 have been vertically shifted upwardly by the respective amounts of 20 dB, 40 dB, 60 dB, 80 dB and 100 dB with respect to curve 500. These vertical shifts to curves 510, 520, 530, 540, 550 represent the amount that the radiation intensity would have changed for conventional radiation based on the different distances of the observation points P (i.e., the decrease, in decibels, of the value of the plotted quantity if its decay had obeyed the inverse square law).

Since the results shown in FIG. 13 have been normalized with respect to distance according to the inverse square law, if conventional radiation were plotted in FIG. 13 for observation points P at the five different distances listed above, the five curves would all fall on top of each other due to the above-described normalization. The separation between the curves in FIG. 13 is a measure of the degree to which the emission by the polarization current antenna 200 decays more slowly with distance than predicted by the inverse square law. Moreover, the improvement in terms of the decrease in the rate of decay of the intensity of the electromagnetic radiation from that predicted by the inverse square law persists with increasing distance (i.e., curve 510 falls above curve 500, curve 520 falls above curve 510, etc.). Thus, for example, for an observation point P that is 10 light cylinder radii from the antenna 200 and located at polar angle of θ_{P}=56.4°, the non-spherically decaying electromagnetic radiation exceeds the conventional spherically-decaying electromagnetic radiation arising from an identical stationary source by about 13 dB (see FIG. 10A). When the observation point P is at a distance of 1,000,000 light cylinder radii from the antenna 200 and again at a polar angle of θ_{P}=56.4°, the combination of FIGS. 10 and 13 illustrate that the non-spherically decaying electromagnetic radiation exceeds the conventional electromagnetic radiation by about 33 dB.

FIG. 13 further illustrates that the rate of decay of the emitted electromagnetic radiation with distance depends on the polar coordinate θ_{P} of the observation point P. This characteristic of the polarization current antenna 200 also differs from that of conventional antennas.

More specifically, FIG. 13 shows that the rate of decay of the emitted electromagnetic radiation with distance increases as the observation point P is moved to polar coordinates that are closer to the equatorial plane (i.e., toward θ_{P}=90 degrees). For example, for observation points P at polar angles of θ_{P}=56.4°, the difference between the normalized value of the radial component of the Poynting vector for an observation point P at a distance of 10 light cylinder radii (see curve 500) and the normalized value of the radial component of the Poynting vector for an observation point P at a distance of 1,000,000 light cylinder radii (see curve 550) is about 20 dB. In contrast, for observation points P at polar angles of θ_{P}=90°, the difference between the normalized value of the radial component of the Poynting vector for an observation point P at a distance of 10 light cylinder radii (see curve 500) and the normalized value of the radial component of the Poynting vector for an observation point P at a distance of 1,000,000 light cylinder radii (see curve 550) is about 5 dB. In other words, FIG. 13 shows that the curves 500, 510, 520, 530, 540, 550 move closer together as θ_{P} increases toward 90°. The closer the curves 500, 510, 520, 530, 540, 550 are together, the closer the rate of decay of the radiation is to the rate of decay predicted by the inverse square law.

As can also be seen in FIG. 13, for each of the six distances to the observation point P (i.e., for curves 500, 510, 520, 530, 540, 550), the radial component of the Poynting vector is largest at θ_{P}=90°. Moreover, a sharp increase in the Poynting vector occurs as the polar angle θ_{P} of the observation point approaches 90°. This sharp increase is observed because an additional mechanism of focusing occurs when the coordinate \hat{z}_{P} of the observation point P falls within the \hat{z}-extent (−\hat{z}₀≦\hat{z}≦\hat{z}₀) of the source distribution. In other words, this additional focusing mechanism occurs for observation points P having a \hat{z}-coordinate that is within the range of the \hat{z}-coordinates of the dielectric radiator 212. This focused beam of electromagnetic radiation propagates into a solid angle encompassing the equatorial plane (θ_{P} =90°), where the polar width of this solid angle is:

π/2−arcsin(\hat{z}₀/\hat{R}_{P})≦θ_{P}≦π/2+arcsin(\hat{z}₀/\hat{R}_{P}) (6)

As \hat{R}_{P} is the distance to the observation point P, in units of c/ω, Equation (6) shows that the width of the focused beam of electromagnetic radiation decreases linearly with distance (i.e., at a rate of 1/\hat{R}_{P}) in the far zone. Since the area subtended by the narrowing solid angle into which the above-described focused beam of electromagnetic radiation propagates decreases linearly with distance (i.e., at a rate of 1/\hat{R}_{P}), while the rate of decay of the magnitude of the Poynting vector with distance for emission into the equatorial plane (θ_{P}=90°) is close to 1/\hat{R}_{P}² (see FIG. 13 where the data points at θ_{P}=90° are close together), it can be seen that the integral of the Poynting vector over any area subtending the narrowing solid angle into which this focused beam of electromagnetic radiation encompassing the equatorial plane propagates decreases with distance. This means that the above-described increase with distance in the flux of energy across surfaces subtending the fixed solid angle within which the Poynting vector decays more slowly than predicted by the inverse square law (i.e., decays at a rate <1/\hat{R}_{P}²), which in this example is the angle 56.4°≦θ_{P}≦123.6°, is partly compensated by the above-described corresponding decrease with distance in the flux of energy across surfaces subtending the narrowing solid angle. π/2−arcsin(\hat{z}₀/\hat{R}_{P})≦θ_{P}≦π/2+arcsin(\hat{z}₀/\hat{R}_{P}), 0≦θ_{P}≦2π, into which the stronger beam of equatorial electromagnetic radiation propagates. In other words, the general increase in the flux of energy with distance that occurs across the full fixed angle into which the non-spherically decaying electromagnetic radiation propagates (56.4°≦θ_{P}≦123.6° in the present example) is partly offset by a decrease in the flux of energy with distance that occurs because the beamwidth of the focused beam of electromagnetic radiation into the equatorial plane narrows. There is also another way in which the non-spherically decaying radiation meets the requirements of the conservation of energy. In the case of a conventional radiation, the flux of energy into any closed region (e.g., into the volume bounded by two spheres centered on the source) equals the flux of energy out of that region at any given time. In the present case, on the other hand, the time-averaged rate of change of the energy density of the non-spherically decaying radiation contained within a closed region of space is always negative, so that the flux of energy out of that region can be greater than the flux of energy into it.

FIG. 14 is a schematic diagram illustrating the different components of the electromagnetic radiation emitted by the polarization current antenna 200. To simplify the figure, the radiation pattern is only shown in one direction. It will be appreciated that the electromagnetic radiation will be emitted throughout a full 360°. The actual radiation pattern of the antenna 200 may be obtained by rotating the three radiation patterns 600, 610, 620 shown in FIG. 14 about the axis of rotation z of the polarization current antenna 200.

As shown in FIG. 14, conventional radiation will be omitted over a broad range of polar angles θ_{P}. The radiation pattern or “antenna beam” formed by this conventional radiation is illustrated in FIG. 14 by the antenna beam 600. Depending upon the design of the antenna, the electrodes 214, 216 of antenna 200 will tend to block the radiation for some range of polar angles near θ_{P}=0° and near θ_{P}=180°, and hence the antenna beam 600 is not shown as encompassing these polar angles. It will be appreciated that a small amount of conventional radiation will be emitted at these polar angles, and that a small amount of conventional radiation (also not shown in antenna beam 600) will also be emitted into the interior of the dielectric radiator 212 of antenna 200.

As is further shown in FIG. 14, non-spherically decaying electromagnetic radiation will be emitted over a smaller range of polar angles θ_{P}. For the example polarization current antenna 200 having the design described above, this smaller range of polar angles is 56.4°≦θ_{P}≦123.6°. This non-spherically decaying electromagnetic radiation is represented in FIG. 14 by the antenna beam 610. The magnitude of the non-spherically decaying electromagnetic radiation per unit area may exceed the magnitude of the conventional radiation by an order of magnitude or more. Finally, the non-spherically decaying electromagnetic radiation includes a very focused beam of radiation which is represented in FIG. 14 by antenna beam 620.

Thus, as shown in FIG. 14, pursuant to embodiments of the present invention polarization current antennas are provided that include a dielectric radiator that extends along an arc, where a radius of the arc defines an equatorial plane. These polarization current antennas are configured to emit a focused beam of electromagnetic radiation into the equatorial plane, the focused beam having an angular elevation beamwidth that decreases with increasing distance from the polarization current antenna (i.e., beam 620 in FIG. 14). These polarization current antennas also are configured to emit a beam of electromagnetic radiation that decays non-spherically with increasing distance from the polarization current antenna (i.e., beam 610 in FIG. 14).

In the above-described polarization current antennas, the angular elevation beamwidth of the non-spherically decaying beam (beam 610) exceeds the angular elevation beamwidth of the focused beam (beam 620). The physical elevation beamwidth of the focused beam 620, which refers to the elevation beamwidth of the focused beam 620 as measured in unit length along a direction perpendicular to the equatorial plane, may be substantially fixed as a function of distance from the polarization current antenna in some embodiments. The physical elevation beamwidth of the focused beam 620 may be substantially equal to a height of the dielectric radiator in the direction perpendicular to the equatorial plane.

The angular elevation beamwidth of the non-spherically decaying beam 610 may be based on a speed of a portion of a polarization current wave that travels through the dielectric radiator at the outer radius of the dielectric radiator during operation of the polarization current antenna. In particular, the angular elevation beamwidth of the non-spherically decaying beam may be equal to:

Elevation Beamwidth=180°−2*arcsin(c/uₘₐₓ), (7)

where c is the speed of light in vacuo and uₘₐₓ is the speed of the polarization current wave at the outer radius of the dielectric radiator.

The polarization current antenna emits an additional beam (beam 600) of electromagnetic radiation that decays spherically with increasing distance from the polarization current antenna. An angular elevation beamwidth of this additional beam may be greater than the angular elevation beamwidth of the non-spherically decaying beam 610.

As noted above, the calculations of the Poynting vector that are provided in FIGS. 10, 12 and 13 are based on a polarization current antenna that has a sinusoidally shaped polarization current wave that travels 10 wavelengths in circling the dielectric radiator 212 once (i.e., m=10). As can be seen in FIG. 13, the gain in the magnitude of the Poynting vector owing to its non-spherical decay over the range in distances to the observation point P from 10 light cylinder radii to 1,000,000 light cylinder radii is about 20 dB for a polar angle of θ_{P}=56.4°. This can be seen in FIG. 13 from the fact that the radial component of the normalized Poynting vector for an observation point P₁ at the polar angle of θ_{P}=56.4° that is at a distance of 10 light cylinder radii is about −11 dB, while the magnitude of the Poynting vector for an observation point P₂ at the same polar angle and a distance of 1,000,000 light cylinder radii is about 9 dB. However, this gain is larger—i.e., the rate of decay of the magnitude of the Poynting vector is slower—the larger the value of the parameter m, which is the number of wavelengths of the polarization current wave that fit around the circumference of the dielectric radiator 212. Since the parameter m is a function of the antenna design, it is possible to increase the gain by designing the antenna to have a larger value of m.

Since the rate of decay of the Poynting vector decreases with increasing values of m, it follows that higher values of m may be desirable for communications over large distances and, in particular, for point-to-point communications over large distances. In other words, by increasing the value of m one can make the rate of decay of the non-spherically decaying electromagnetic radiation be closer to 1/d, and hence higher antenna gain may be achieved at these large distances than would conventionally be possible. Based on this, a method of designing the above-described polarization current antennas according to embodiments of the present invention is to select the number of polarization elements, the frequency of the input signal and the time difference between the instants at which the input signal is applied to adjacent polarization elements attains maximum value so that the polarization current antenna will generate a polarization current wave that will have a pre-selected number of wavelengths that fit around the circumference of the arc-shaped dielectric radiator, where the pre-selected number of wavelengths is selected based at least in part on a distance to an antenna that is to receive signals transmitted by the polarization current antenna. In some embodiments, the pre-selected number of wavelengths may be at least ten wavelengths. In other embodiments, the pre-selected number of wavelengths may be greater than fifteen wavelengths. In still other embodiments, the pre-selected number of wavelengths may be greater than twenty wavelengths. In yet other embodiments, the pre-selected number of wavelengths may be greater than twenty-five wavelengths.

As described above, the polarization current antenna 200 has, among other things, the following properties that are different than the properties of conventional, non-polarization current antennas:
1. The flux of energy decays more slowly with distance than predicted by the inverse square law;
2. The rate of decay of the flux of energy with distance increases as the observation point moves closer to the equatorial plane; and
3. The general increase in the flux of energy with increasing distance that occurs across the full fixed angle into which the non-spherically decaying electromagnetic radiation propagates is partly offset by a decrease in the flux of energy with increasing distance that occurs as the beamwidth of the focused beam of electromagnetic radiation into the equatorial plane narrows.
4. The time-averaged rate of change of the energy density of the non-spherically decaying radiation contained within a closed region of space is always negative, so that the flux of energy out of that region can be greater than the flux of energy into it.

The above-described properties of the equatorially emitting polarization current antenna have a number of interesting implications for purposes of antenna design. For instance, FIG. 10 shows that the strongest emission occurs in the direction of observation points P that are in or near the equatorial plane. However, as the distance to the observation point P increases, the elevation beamwidth of the focused equatorial beam narrows linearly with distance. Thus elevation beamwidth requirements may limit the distances where this component of the radiation from the polarization current antenna is suitable for certain applications.

As discussed above, the angular elevation beamwidth for the non-spherically decaying electromagnetic radiation emitted by polarization current antennas according to embodiments of the present invention may be controlled by designing the antenna to generate a polarization current wave that has a speed at the outer radius of the dielectric radiator that provides a desired angular elevation beamwidth. The physical elevation beamwidth of the focused beam of electromagnetic radiation that is emitted into the equatorial plane that has an angular elevation beamwidth that decreases with increasing distance from the polarization current antenna (i.e., beam 620 in FIG. 14 above) may be controlled by selection of the height Δz of the dielectric radiator. Moreover, the angular azimuth beamwidth of the non-spherically decaying electromagnetic radiation emitted by polarization current antenna will be equal to the angular arc length y of the arc-shaped dielectric radiator.

Accordingly, the polarization current antennas according to embodiments of the present invention may be designed to have desired azimuth and elevation beamwidths by (1) selecting an angular arc length of the arc-shaped dielectric radiator to provide a pre-selected angular azimuth beamwidth for a beam of electromagnetic radiation that is emitted by the polarization current antenna that is non-spherically decaying with distance from the polarization current antenna and (2) selecting properties of the polarization current in the arc-shaped dielectric radiator to provide a pre-selected elevation beamwidth for the beam of electromagnetic radiation that is emitted by the polarization current antenna that is non-spherically decaying with distance from the polarization current antenna.

In some cases, the goal may be to select a desired elevation beamwidth for the focused beam of electromagnetic radiation 620 that is discussed above with reference to FIG. 14. In such embodiments, the pre-selected elevation beamwidth may be a pre-selected physical elevation beamwidth, and the property of the arc-shaped dielectric radiator that is selected to set the physical elevation beamwidth is the height Δz of the arc-shaped dielectric radiator.

In other cases, the pre-selected elevation beamwidth may be a pre-selected angular elevation beamwidth. In such cases, properties of the polarization elements and properties of signals supplied to the polarization elements may also be selected so as to provide the pre-selected angular elevation beamwidth for the beam of electromagnetic radiation that is emitted by the polarization current antenna that is non-spherically decaying with distance from the polarization current antenna. The properties of the arc-shaped dielectric radiator that are selected may comprise a radius of the arc-shaped dielectric radiator. The properties of the polarization elements that are selected may comprise a number of polarization devices and a distance between adjacent polarization elements. The properties of the signals supplied to the polarization elements that are selected may comprise a frequency of the signals and a phase difference between the oscillations of adjacent polarization elements.

The polarization current antennas according to embodiments of the present invention have unique properties that may be particularly well-suited for certain applications. For example, conventional antennas typically emit a main beam of electromagnetic radiation in a given direction along with a plurality of less intense beams of electromagnetic radiation that are emitted in directions on either side of the main beam. These less intense beams of electromagnetic radiation are typically referred to as “sidelobes.” Sidelobes are undesirable in many applications where a goal is to provide coverage to an area using the main beams of multiple different antennas, where each main beam covers a “sector” of the coverage area, as the sidelobes of an antenna beam that covers a first sector may fall within one or more adjacent sectors. When this occurs, the sidelobes may appear as interference to the main beams in the adjacent sectors. This is a common issue, for example, in cellular communications systems. A common technique to mitigate this issue is to transmit on different frequencies in adjacent sectors in order to avoid the interference problem.

The electromagnetic radiation or “beam” patterns of the polarization current antennas according to embodiments of the present invention do not have sidelobes in the traditional sense, although they may be designed to emit three distinct types of radiation as discussed above with reference to FIG. 14, namely a first beam 600 of conventional (i.e., spherically decaying) electromagnetic radiation, a second beam 610 of non-spherically decaying electromagnetic radiation, and a third very narrow beam 620 of highly focused non-spherically decaying electromagnetic radiation that subtends a smaller angle with increasing distance. By adjusting the properties of the polarization current waves that flow in the dielectric radiators of the polarization current antennas according to embodiments of the present invention (which can be done by adjusting physical properties of the polarization current antenna and/or the signal fed thereto in the manner described above), the shapes and other properties of the three above-described beams 600, 610, 620 of electromagnetic radiation may be adjusted. Thus, the polarization current antennas according to embodiments of the present invention may be designed to have reduced “sidelobes” when used in applications where sidelobes are problematic.

For example, as discussed above, the polar angles subtended by the second beam 610 of non-spherically decaying electromagnetic radiation shown in FIG. 14 may be readily changed by adjusting the speed of the polarization current wave within the dielectric radiator of the polarization current antenna. Moreover, as shown in FIGS. 10 and 13, the second beam 610 may have a relatively constant magnitude across most polar angles into which the second beam 610 is emitted, as the increase in intensity that occurs at polar angles of about 90° is primarily due to the third beam 620 of highly focused non-conventional radiation, at least for the range of distances shown by the curves included in FIG. 13 (i.e., distances of 10 to 1,000,000 light cylinder radii). For example, it can be seen that between the polar angles of θ_{P}=60° and θ_{P}=80° the change in intensity of the non-conventional (i.e., non-spherically decaying) electromagnetic radiation (i.e., the combination of antenna beams 610 and 620) is only about 5 dB in the example of FIG. 10, and FIG. 13 shows that the intensity varies even less with increasing distance. Moreover, while the conventional electromagnetic radiation represented by beam 600 of FIG. 14 may be considered to be akin to a sidelobe, FIG. 10 shows that the intensity of beam 600 is significantly lower than the intensity of the non-conventional radiation (i.e., the combination of beams 610 and 620), and that the intensity of beam 600 drops off very rapidly. For example, the maximum value of beam 600 in the example of FIG. 10 is almost 13 dB less than the minimum value of the combination of beams 610 and 620, and the magnitude of beam 600 falls off by nearly an additional 10 dB over the next 10° of elevation beamwidth (i.e., the magnitude of the “sidelobes” of the polarization current antenna fall off sharply).

Moreover, it is possible to design the polarization current antennas to control the ratio of the intensity of the non-conventional (beams 610 and 620 of FIG. 14) and conventional (beam 600 of FIG. 14) electromagnetic radiation. For example, by increasing the value of the parameter in, this ratio may be increased. As described above, other parameters may also be adjusted that impact the ratio of the intensity of the non-conventional and conventional electromagnetic radiation. Thus, the polarization current antennas according to embodiments of the present invention have the unusual property that the ratio of the magnitude of the main lobe of electromagnetic radiation to the magnitude of the sidelobes may be adjusted. This is a highly desirable property, as in most applications the sidelobes at a minimum represent “lost” radiation that does not produce any benefit and reduces the amount of radiation within the main lobe, and in many cases the sidelobes may also represent an interfering signal for an antenna covering an adjacent sector that acts to degrade the performance of this adjacent antenna.

As discussed above, the parameter in is a function of (1) the number of polarization elements, (2) the frequency of an input signal to the polarization current antenna and (3) a time difference between the instants at which the input signal is applied to adjacent polarization elements attains maximum value. Thus, one or more of these parameters may be selected so that a portion of the spherically decaying electromagnetic radiation that is emitted by the polarization current antenna that is emitted outside a range of polar angles where the non-spherically decaying electromagnetic radiation is emitted has a maximum intensity that is at least a pre-selected level lower than a maximum intensity of the non-spherically decaying electromagnetic radiation at a first distance from the polarization current antenna. In other words, with reference to FIG. 10, parameters of the polarization current antenna may be selected to ensure that the step function in the Poynting vector that occurs at=56.4° is at least a pre-selected minimum value such as, for example, 10 dB, 12 dB, 15 dB, 18 dB, 20 dB, 25 dB, 30 dB, 35 dB or 40 dB in various embodiments. As described above, this may be done to ensure that the sidelobe levels of the antenna are at suitably low levels. The first distance may be, for example, a distance to a second antenna that is configured to receive signals transmitted by the polarization current antenna.

The above-discussed properties of the polarization current antennas according to embodiments of the present invention may be used in designing the properties of the polarization current antennas for certain applications. For example, in designing the parameters of a polarization current antenna for point-to-multipoint applications, the antenna may be designed to generate a polarization current wave that travels in the dielectric radiator of the antenna at a speed such that the antenna will emit non-spherically decaying electromagnetic radiation over a range of polar angles that corresponds to a desired elevation beamwidth of the antenna. As shown in Equation (6) above, this may be accomplished by designing the antenna so that the speed of the polarization current wave at the outer radius of the dielectric radiator generates a beam 610 of non-spherically decaying electromagnetic radiation that has a desired elevation beamwidth. As discussed above, the speed of the polarization current wave is a function of (1) various parameters of the arc-shaped dielectric radiator (e.g., radius, thickness, etc.), (2) various parameters of the polarization devices (e.g., distance between adjacent polarization devices, the total number of polarization devices, etc.) and (3) the feed network (e.g., the time difference between the instants at which the input signals applied to adjacent polarization devices attain maximum amplitude). Thus, these parameters may be designed so that the polarization current antenna generates a polarization current wave having a speed at the outer radius of the dielectric radiator that results in the polarization current antenna emitting non-spherically decaying electromagnetic radiation over a desired elevation beamwidth. Likewise, the angle φ of the arc defined by the arc-shaped dielectric radiator may be chosen to select an azimuth beamwidth for the polarization current antenna. Additionally, various parameters of the polarization current antenna such as the parameter m may be selected so that a maximum intensity of a portion of a beam of conventional radiation that is emitted outside the range of polar angles at which the non-spherically decaying electromagnetic radiation is emitted is below a pre-selected level. As discussed above, this portion of the conventional spherically decaying electromagnetic radiation corresponds to the “sidelobe” of the polarization current antenna. Thus, the polarization current antennas according to embodiments of the present invention may be readily designed to have sidelobes that are at or below pre-selected levels with respect to, for example, the maximum intensity value of the main beam at a pre-selected distance (or a range of distances).

Another property of the polarization current antennas according to embodiments of the present invention is that the design of the antenna may be adjusted to increase the directive gain of the antenna at a given distance. In fact, the polarization current antennas according to embodiments of the present invention may achieve directive gain values that are comparable to very large parabolic dish reflector antennas while having an antenna size that is a small fraction of the size of such a parabolic dish reflector antenna. In particular, by varying one or more parameters of the arc-shaped dielectric radiator, the polarization devices and/or the feed network, the directive gain of the antenna in a direction of peak emission may be changed in known, predictable ways. Thus, it is possible to design the antennas to have at least a pre-selected directive gain value at a pre-selected distance. As noted above, one parameter that may have a significant impact on the directive gain is the parameter m, which is the number of wavelengths of the polarization current wave that fit within one rotation of the dielectric radiator. By changing the value of the parameter m, the directive gain of the antenna, at a given distance, may be changed. The parameter m is a function of the number of polarization elements, the frequency of the input signal and the time difference between the instants at which the input signal is applied to adjacent polarization elements attains maximum value, as is discussed above.

Yet another property of the polarization current antennas according to embodiments of the present invention is that they generate a very focused beam of non-spherically decaying electromagnetic radiation corresponding to the beam 620 in FIG. 14. This beam of radiation has an angular beamwidth (in the embodiments discussed above, an angular elevation beamwidth) that narrows with increasing distance from the polarization current antenna. Thus, pursuant to further embodiments of the present invention, polarization current antennas are provided that include (1) a dielectric radiator and (2) a plurality of polarization devices that are configured to generate an electric field within the dielectric radiator, where the polarization current antenna is configured to generate a beam of electromagnetic radiation that has an angular beamwidth that narrows with increasing distance from the dielectric radiator. This narrow beam of focused radiation may have a very high intensity in the near field.

Another unique and useful property of the polarization current antennas according to embodiments of the present invention is the fact that the beamwidth and pointing direction of the non-spherically decaying portion of the radiation pattern (herein the “non-spherically decaying radiation beam”) generated by these antennas may be readily adjusted in the design process of the antenna. As discussed above, the speed of the polarization current wave at the inner diameter of the dielectric radiator uₘᵢₙ and the speed of the polarization current wave at the outer diameter of the dielectric radiator uₘₐₓ may be set by selection of the (1) the total number of polarization elements N, (2) the mean radius r₀ of the arc-shaped dielectric radiator, (3) the time difference Δt between the instants at which the input signals applied to adjacent polarization elements attain maximum amplitude and (4) the frequency ν of the input signal. To have the polarization current antenna of FIGS. 7-9 emit the non-spherically decaying radiation beam into the equatorial plane it is necessary for the speed of the polarization current wave to be equal to the speed of light at some point within the dielectric radiator.

By designing the polarization current antenna of FIGS. 7-9 so that it generates a polarization current wave that has a speed that exceeds the speed of light throughout the dielectric radiator, the non-spherically decaying radiation beam may be moved away from the equatorial plane. As discussed above, the antenna beam generated by the polarization current antenna of FIGS. 7-9 is symmetrical about the equatorial plane, and hence when the antenna is designed so that the non-spherically decaying radiation beam is not emitted into the equatorial plane, a pair of non-spherically decaying radiation beams may be generated that are on either side of the equatorial plane. The average speed of the polarization current wave determines the position of each non-spherically decaying radiation beam with respect to the equatorial plane. Moreover, the difference in the speed of the polarization current wave at the inner diameter of the dielectric radiator uₘᵢₙ and the speed of the polarization current wave at the outer diameter of the dielectric radiator uₘₐₓ determines the angular elevation beamwidths of the non-spherically decaying radiation beams. Thus, in the design phase of polarization current antennas according to embodiments of the present invention a designer may select a pointing direction and an angular elevation beamwidth for the non-spherically decaying radiation beams. In addition, by selecting the extent of the arc-shaped dielectric radiator in the azimuth plane, the azimuth beamwidth of the polarization current may be selected. Accordingly, a designer may readily design polarization current antennas according to embodiments of the present invention that have non-spherically decaying radiation beams with desired coverage areas.

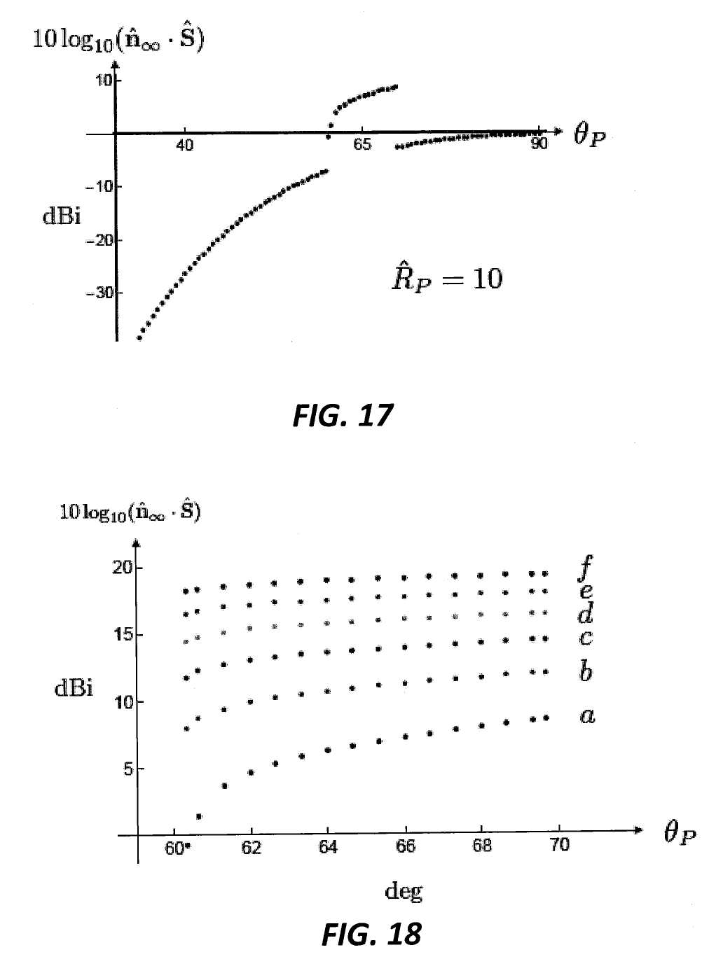

FIGS. 17-20 illustrate the ability to vary the angular elevation beamwidth and the beam pointing direction of the non-spherically decaying radiation beams generated by the polarization current antennas according to embodiments of the present invention. In particular, FIGS. 17-20 are graphs that illustrate various aspects of the radiation pattern of a polarization current antenna according to embodiments of the present invention in which the non-spherically decaying radiation beams are outside the equatorial plane. The polarization current antenna that was modelled to generate the graphs of FIGS. 17-20 had the general design of the polarization current antenna discussed above with reference to FIGS. 7-9 with the following parameters:
uₘᵢₙ=speed at inner radius=csc(7π/18)=1.0642c
uₘₐₓ=speed at outer radius=csc(π/3)=1.1547c
φ=angle of arc=360°
Δl=center-to-center distance between adjacent polarization elements=1 cm
ν=frequency of the signal to be transmitted=2.3 GHz
ΔΦ=phase difference between oscillations of adjacent polarization elements=25°
m=the number of wavelengths of the polarization current wave that fit around the circumference of the arc-shaped dielectric radiator=10
N=number of polarization elements=144
r₀=mean radius of the dielectric radiator=23.03 cm
Δr=radial width of the dielectric radiator=1.88 cm
Δz=height of the dielectric radiator=4.15 cm
c/ω=radius of the light cylinder=20.76 cm

The time-averaged value of the component of the Poynting vector along the radiation direction (i.e., the power emitted by the polarization current antenna that propagates across a unit area normal to the radiation direction at a given observation point P) was solved for the polarization current antenna having the above-described parameters. FIG. 17 is a graph of the modelled directive gain for this polarization current antenna as a function of the polar coordinate of observation points that are at a fixed distance from the antenna. FIG. 17 is the equivalent of FIG. 10 above, except that it shows the results for a polarization current antenna having a different design. Thus, FIG. 17 illustrates the directive gain of the antenna at various observation points P that are each at a distance of ten light cylinders (2.076 meters) from the antenna, as a function of the polar angle θ_{P} of the observation point P. FIG. 17 only shows half of the radiation pattern, since the radiation pattern is symmetric with respect to the equatorial plane θ_{P}=90°.

As described above with reference to FIG. 10, the curve formed by the data points in FIG. 17 represents the received power per unit area of the electromagnetic radiation emitted by the polarization current antenna. This curve includes received power that is generated by both (1) source elements of the antenna that have a velocity component along the direction the electromagnetic radiation travels to the observation point P that is less than the speed of light in vacuo (c) and by (2) source elements of the antenna that have a velocity component along the direction the electromagnetic radiation travels to the observation point P that is greater than or equal to the speed of light in vacuo (c). As shown in FIG. 17, the polarization current antenna emits non-spherically decaying radiation at polar angles of about 60°≦θ_{P}≦70°, and only emits conventional radiation at polar angles in the ranges of 0°≦θ_{P}≦60° and 70°≦θ_{P}≦90°. The magnitude of the non-spherically decaying radiation significantly exceeds the magnitude of the conventional radiation. Thus, the polarization current antenna design corresponding to FIG. 17 primarily emits radiation into first and second regions that are about 25 degrees above and below the equatorial plane that each have an angular beamwidth of about ten degrees in the elevation plane. It should also be noted that these individual beams are not symmetric, but instead have peak radiation at θ_{P}=70° and θ_{P}=110°, respectively (i.e., peak emission is at an edge of the beam as opposed to in the center of the beam as is typically the case with conventional radiation).

As discussed above, the non-spherically decaying radiation, which for the antenna modelled with respect to the results shown in FIG. 17 is emitted into the regions of about 60°≦θ_{P}≦70° and 110°≦θ_{P}≦120°, has a dependence on θ_{P} that varies with the distance of the observation point P from the antenna. This is illustrated graphically in FIG. 18, which is a graph showing the radial component of the time-averaged Poynting vector divided by the average power that propagates across a sphere of radius \hat{R}_{P}=10 per unit solid angle as a function of the polar coordinate θ_{P} of the observation point P (for 60°≦θ_{P}≦70°) for observation points P at six different distances from the polarization current antenna. The six curves a-f shown in FIG. 18 correspond to observation points P at distances of 10, 100, 1,000, 10,000, 100,000 and 1,000,000 light cylinder radii from the polarization current antenna, respectively, which encompass distances of about 2 meters to 200 kilometers. In FIG. 18 the curves have been vertically shifted upwardly by the respective amounts of 20 dB, 40 dB, 60 dB, 80 dB and 100 dB with respect to curve a as was done in the case of FIG. 13 to represent the amount that the radiation intensity would have changed for conventional radiation based on the different distances of the observation points P. Thus, the separation between the curves a-f in FIG. 18 illustrates the degree to which the emission by the polarization current antenna decays more slowly with distance than predicted by the inverse square law.

As can also be seen in FIG. 18, for each of the six distances to the observation point P (i.e., for curves a-f), the radial component of the Poynting vector is largest at θ_{P}=70°. However, the sharp increase in the Poynting vector that is seen in FIG. 13 at θ_{P}=90° is not present when the non-spherically decaying radiation beams are outside the equatorial plane as the non-spherically decaying radiation beams that are above and below the equatorial plane do not converge as was the case with the polarization current antenna that was modelled to generate the graph of FIG. 13.

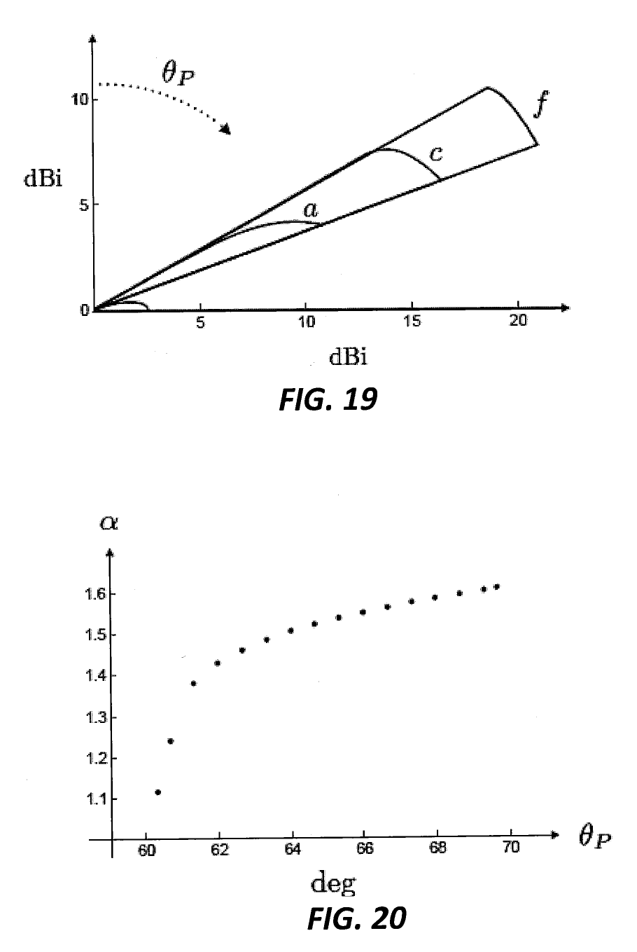

FIG. 19 is another representation of the data regarding the intensity of the electromagnetic radiation emitted by the above-described polarization current antenna as a function of the polar coordinate of the observation point P. In particular, curve a of FIG. 19 illustrates the same data shown in FIG. 17, but FIG. 19 plots this data in a polar coordinate system. In FIG. 19 the data has been normalized so that the radial coordinates have positive values. The three dimensional radiation pattern for the polarization current antenna at \hat{R}_{P}=10 may be obtained from curve a of FIG. 19 by adding the reflection of curve a shown in FIG. 19 across the equatorial plane (the horizontal axis) and then rotating the plotted data about the z-axis. Curves c and f of FIG. 19 show the counterparts of curve a of this figure at \hat{R}_{P}=10³ and \hat{R}_{P}=10⁶ respectively, i.e., plot the data shown in curves c and f of FIG. 18 in a polar coordinate system.

In FIG. 19, the emitted radiation at polar angles of 0°≦θ_{P}≦60° is sufficiently weak that it does not appear in the graph. The emitted radiation at polar angles of 70°≦θ_{P}≦90° is also quite weak as compared to the emission at polar angles of 60°≦θ_{P}≦70° which is the portion of the emission that is non-spherically decaying radiation.

FIG. 20 is graph of the exponent α of the distance dependence \hat{R}_{P}^{-α} of the radial component of the Poynting vector over the range \hat{R}_{P}=10 to \hat{R}_{P}=10⁶ as a function of the polar angle θ_{P} for values of θ_{P} in the range 60°≦θ_{P}≦70°. The plot of FIG. 20 was obtained in the same manner as the plot of FIG. 16.

The above modelling indicates that the average value of the power that propagates across the sphere \hat{R}_{P}=10 per unit of solid angle is 3.5×10⁻³ |j_{z}|² Watt/m², where |j_{z}| represents the amplitude of the electric current density in amps/m². The radiation is completely linearly polarized with a fixed polarization angle that is parallel to the axis of rotation z, and hence is vertically polarized.

The polarization current antennas according to embodiments of the present invention that are described above have polarization currents that are parallel to the axis of rotation z. These polarization current antennas may be referred to as polarization current antennas having “axial” polarization currents. As discussed above with reference to FIG. 1, polarization current antenna designs are also known in which the electrodes are mounted on the inner and outer surfaces of a ring-shaped (or arc-shaped) dielectric radiator. In such polarization current antennas, the polarization currents are perpendicular to the axis of rotation z. These polarization current antennas may be referred to as polarization current antennas having “radial” polarization currents. For purposes of comparison, a polarization current antenna that has radial polarization current was modelled that is similar to the polarization current antenna having axial polarization current that is described above with reference to FIGS. 17-20.

The polarization current antenna with radial polarization current that was modelled had the general design of the polarization current antenna discussed above with reference to FIG. 1 with the following parameters:
uₘᵢₙ=speed at inner radius=csc(7π/18)=1.0642c
uₘₐₓ=speed at outer radius=csc(π/3)=1.1547c
φ=angle of arc=360°
Δl=center-to-center distance between adjacent polarization elements=1.015 cm
ν=frequency of the signal to be transmitted=2.5 GHz
ΔΦ=phase difference between oscillations of adjacent polarization elements=27.7°
m=the number of wavelengths of the polarization current wave that fit around the circumference of the arc-shaped dielectric radiator=10
N=number of polarization elements=130
r₀=mean radius of the dielectric radiator=21 cm
Δr=radial width of the dielectric radiator=3.8 cm
Δz=height of the dielectric radiator=3.8 cm
c/ω=radius of the light cylinder=19.1 cm

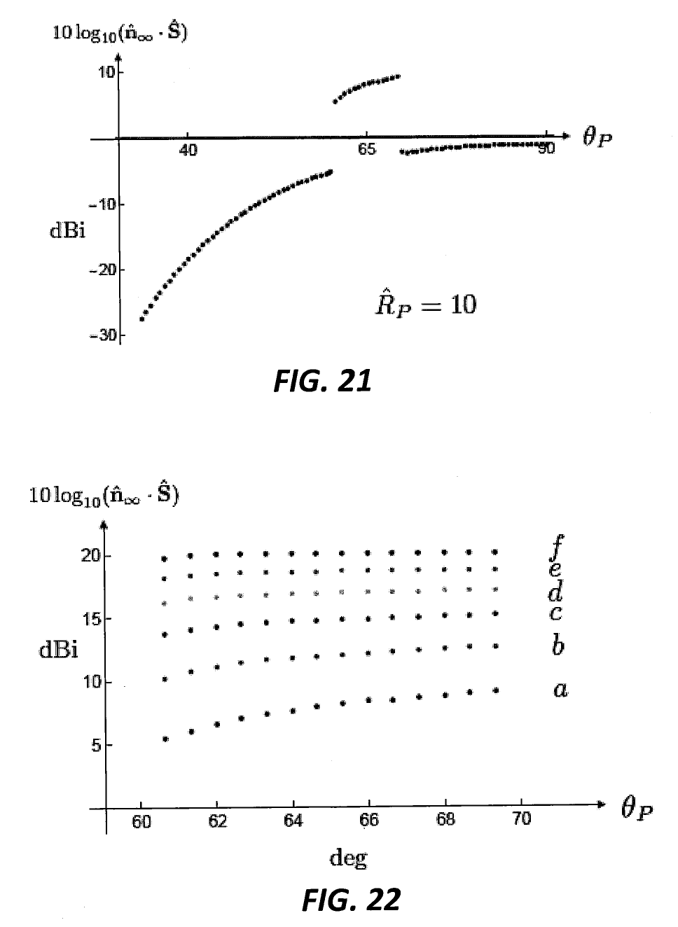

FIGS. 21-24 show the same information as FIGS. 17-20, respectively, for the above-described polarization current antenna with radial polarization current. As can be seen, the modelled results in FIGS. 21-24 are similar to the corresponding modelled results (shown in FIGS. 17-21) for the polarization current antenna having axial polarization current. Accordingly, further description thereof will be omitted here. The modelling further indicated that the average value of the power that propagates across the sphere \hat{R}_{P}=10 per unit of solid angle is 2.93×10⁻³|j_{z}|² Watt/m², which again is similar to the modelled results for the polarization current antenna having axial polarization current.

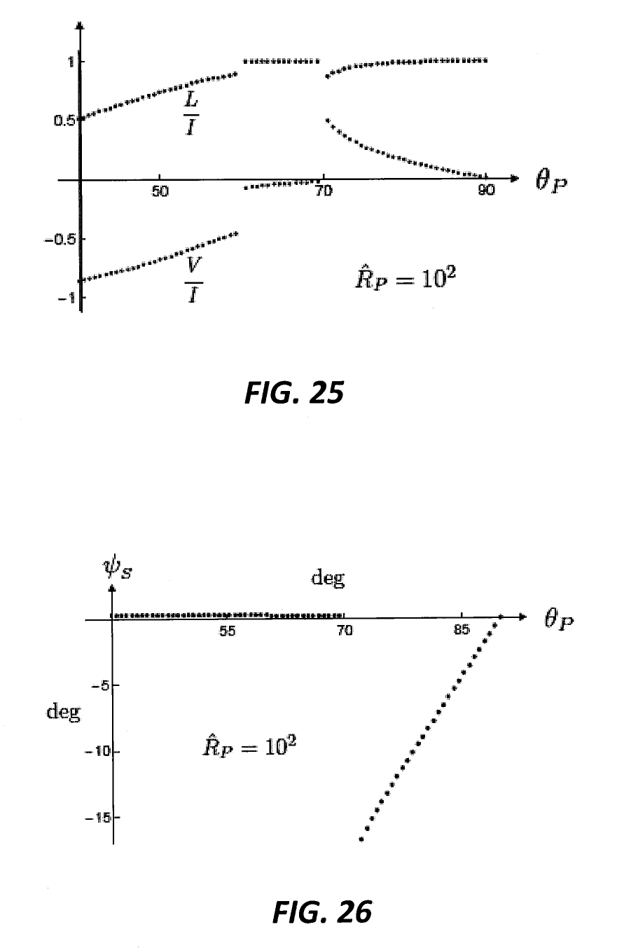

For observation points P having polar coordinates in the ranges 60°≦θ_{P}≦70° and 110°≦θ_{P}≦120° the radiation is almost 100 percent linearly polarized with a fixed polarization angle that is perpendicular to the axis of rotation z, and hence is horizontally polarized. However, the polarization of the emitted radiation in the direction of observation points P having polar coordinates in the other ranges is not fully linear, as can be seen with reference to FIGS. 25 and 26. In particular, FIG. 25 is a graph illustrating the fractions of linear polarization and circular polarization as a function of the polar angle θ_{P} for the radiation generated by the polarization current antenna used in the modelling results of FIGS. 21-24 at \hat{R}_{P}=10². In FIG. 25, the upper curve illustrates the fraction of linear polarization (L/I) and the lower curve illustrates the fraction of circular polarization (V/I). FIG. 26 is a graph that converts the information from FIG. 25 to illustrate the polarization position angle as a function of the polar angle θ_{P}. As can be seen from FIG. 26, the emitted radiation is almost 100 percent linearly polarized for observation points P having polar coordinates in the range of 60°≦θ_{P}≦70°, while the emitted radiation is elliptically polarized for observation points P having polar coordinates in the range 70°≦θ_{P}≦90°.

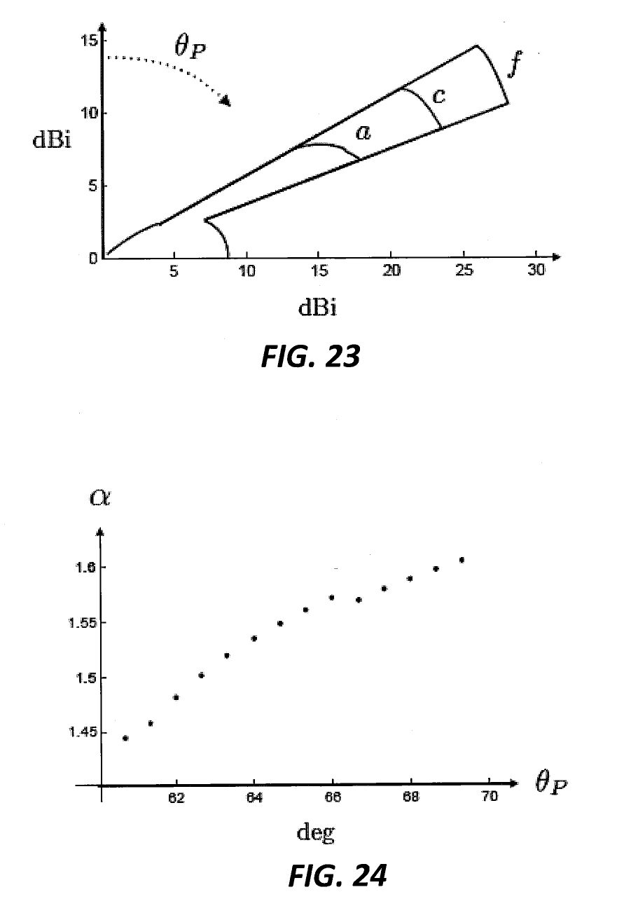

The above modelling results show that the polarization current antennas according to embodiments of the present invention may generate antenna beams that may be tightly focused and that can be steered in various directions. In particular, by selecting the speeds of the polarization current wave at the inner and/or outer diameters of the dielectric radiator (which can be accomplished by varying certain parameters of the polarization current antenna and/or the input signal, as described above), the polarization current antennas according to embodiments of the present invention may be configured to generate antenna beams that have selectable pointing directions and/or elevation beamwidths. FIGS. 19 and 23 in particular show how most of the emitted radiation may be (at least theoretically) directed toward observation points P having polar coordinates in a defined range, meaning that the polarization current antennas according to embodiments of the present invention may be designed to generate low levels of interference for other communication systems. This attribute may be advantageous for communications systems operating in environments that currently have high levels of interference, such as urban areas.

Other types of antennas are known in the art that can provide highly focused antenna beams, such as parabolic reflector antennas and phased array antennas. However, these antennas may be relatively large in size, particularly when operated at lower frequencies such as frequencies in the 100 MHz to 3 GHz range, and the radiation emitted by these antennas is conventional spherically decaying radiation. The polarization current antennas according to embodiments of the present invention may be smaller than conventional antennas while emitting radiation that does not attenuate as quickly as a function of a distance and that can be mostly emitted into a region having selectable azimuth and elevation beamwidths that is located at a selected pointing angle.

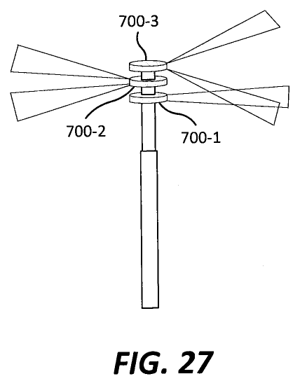

FIG. 27 is a schematic diagram illustrating an example application for the polarization current antennas according to embodiments of the present invention. As shown in FIG. 27, a cellular base station may include a plurality of polarization current antennas 700-1, 700-2, 700-3 that are each designed to emit non-spherically decaying radiation into regions having different elevation angles. In the depicted embodiment, antenna 700-1 emits non-spherically decaying radiation in the direction of observation points having polar coordinates in the ranges 85°≦θ_{P}≦95°, antenna 700-2 emits non-spherically decaying radiation in the direction of observation points having polar coordinates in the ranges 75°≦θ_{P}≦85° and 95°≦θ_{P}≦105°, and antenna 700-3 emits non-spherically decaying radiation in the direction of observation points having polar coordinates in the ranges 60°≦θ_{P}<75° and 105°<θ_{P}<120°. The three antennas 700-1, 700-2, 700-3 may all be mounted on the same structure if desired, as the radiation patterns of the three antennas may exhibit low levels of interference with one another.

As described above, each polarization current antenna may have a different design so that the speeds of the polarization current waves generated in the dielectric radiators of each of polarization current antennas 700-1, 700-2, 700-3 may be different so that the three polarization current antennas will emit non-spherically decaying radiation into the three different ranges of elevation angles. In some embodiments, the radiation patterns of the antennas may be sufficiently tightly focused so that all three antennas 700-1, 700-2, 700-3 may transmit at the same frequency.

In some embodiments, the polarization current antennas 700-1, 700-2, 700-3 may each be configured to emit the non-spherically decaying radiation into a full 360 degrees in the azimuth plane so that each antenna 700-1, 700-2, 700-3 provides omnidirectional coverage in the azimuth plane, while each antenna 700-1, 700-2, 700-3 provides coverage to a different portion of the elevation plane. In this fashion, the three antennas 700-1, 700-2, 700-3 may together operate as a base station antenna that provides full omnidirectional coverage in the azimuth plane and suitable coverage in the elevation plane. Since each antenna 700-1, 700-2, 700-3 may transmit at the same frequency and at the same time as the other two antennas due to the low levels of interference between their respective antenna beams, the capacity of the base station may be enhanced.

Moreover, it will be understood that additional polarization current antennas may be added to the base station of FIG. 27. For example, if the angular elevation beamwidth of each polarization current antenna 700-1, 700-2, 700-3 is cut in half, then a total of six polarization current antennas may be used to cover the same total range of elevation beamwidths, and the capacity of the base station may be further increased. Likewise, each antennas 700-1, 700-2, 700-3 may be replaced with multiple antennas that each only cover a sector in the azimuth plane. For example, each antenna 700-1, 700-2, 700-3 could be replaced with three antennas that each have a dielectric radiator that extends for 120° of a circle to sectorize the base station in the azimuth plane. This may further increase the capacity of the base station. Notably, in order to reduce the elevation beamwidth of most conventional base station antennas it is necessary to add more radiating elements to the base station antenna or an RF lens, which increases the size of the antenna. With the polarization current antennas according to embodiments of the present invention the elevation beamwidth may be reduced while keeping the size of the antenna nearly constant, making it practical to deploy a large number of polarization current antennas at a base station, each of which has a small elevation beamwidth. In some embodiments, at least some of the polarization current antennas may be designed to cover a range of elevation angles that is less than 10 degrees. In other embodiments, at least some of the polarization current antennas may be designed to cover a range of elevation angles that is less than 5 degrees. In still other embodiments, at least some of the polarization current antennas may be designed to cover a range of elevation angles that is less than 2 degrees. In yet further embodiments, at least some of the polarization current antennas may be designed to cover a range of elevation angles that is less than 1 degree.

In some embodiments, each polarization current antenna may be designed to cover a different range of elevation angles, and these ranges may not be overlapping. Such an approach, however, may result in users that are at elevation angles between the ranges not having adequate coverage. Accordingly, in other embodiments, the ranges of elevation angles may be at least partially overlapping. In such embodiments, it may be advantageous to have polarization current antennas that have overlapping ranges of elevation angles to be configured to transmit at different frequencies. For example, in the scenario of FIG. 27, polarization current antennas 700-1 and 700-3 could be configured to transmit signals in a first frequency range and polarization current antenna 700-2 could be configured to transmit signals in a second frequency range that is different from (and non-overlapping with) the first frequency range.

In some embodiments, the ranges of elevation angles covered by at least some of the polarization current antennas 700-1, 700-2, 700-3 may be different. In other words, at least some of the polarization current antennas may have different elevation beamwidths for their non-spherically decaying emissions. This may be advantageous because the number of users may typically differ for different ranges of elevation beamwidths (e.g., more users may be at elevation angles that are close to the horizon).

While example embodiments of the present invention have been described above, it will be appreciated that many modifications may be made to these example embodiments without departing from the scope of the present invention. For example, while the polarization current antennas that are discussed above have arc-shaped dielectric radiators that have a constant radius, it will be appreciated that embodiments of the present invention are not limited thereto. In particular, in other embodiments, the radius of the arc may vary along the length of the arc to provide a curved dielectric radiator having a non-constant radius.

As another example, the dielectric radiators that are discussed above are in the form of an arc-shaped strip. While such a strip is a convenient shape for the dielectric radiator, it will be appreciated that other shapes may also be used to support a travelling volume polarization current distribution pattern. Thus, it is contemplated that electrodes or other polarization devices may be on, embedded in or otherwise coupled to dielectric radiators having shapes other than arc-shaped strips. For example, s-shaped dielectric radiators could be used in some embodiments. Many other shapes are possible. As yet another example, electrodes (including ground planes) are used as examples of polarization devices that may be used to polarize the dielectric radiator. It will be appreciated, however, that any suitable polarization devices may be used in further embodiments of the present invention.

While the present invention has been described above primarily with reference to the accompanying drawings, it will be appreciated that the invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. As one specific example, various features of the communications jacks of the present invention are described as being, for example, adjacent a top surface of a dielectric radiator. It will be appreciated that if elements are adjacent a bottom surface of a dielectric radiator, they will be located adjacent the top surface if the device is rotated 180 degrees. Thus, the term “top surface” can refer to either the top surface or the bottom surface as the difference is a mere matter of orientation.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “on,” “attached,” “connected,” “contacting,” “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1-58. (canceled)

59. A method of operating a polarization current antenna having an arc-shaped dielectric radiator that is configured to emit electromagnetic radiation into an equatorial plane defined by a radius of the arc-shaped dielectric radiator, the method comprising:
generating a polarization current wave in the arc-shaped dielectric radiator, where the polarization current antenna is configured so that the polarization current wave will have a pre-selected speed at the outer radius of the arc-shaped dielectric radiator, where the pre-selected speed is selected so that a beam of non-spherically decaying electromagnetic radiation that is generated by the polarization current wave has a pre-selected angular elevation beamwidth.

60. The polarization current antenna of claim 59, wherein the pre-selected speed of the polarization current wave at the outer radius of the arc-shaped dielectric radiator is between the speed of light in vacuo and 1.2 times the speed of light in vacuo.

61. The polarization current antenna of claim 59, wherein the pre-selected speed of the polarization current wave at the outer radius of the arc-shaped dielectric radiator is between the speed of light in vacuo and 1.02 times the speed of light in vacuo.

62-79. (canceled)

80. A cellular base station, comprising:
a first polarization current antenna; and
a second polarization current antenna,
wherein the first polarization current antenna is configured to emit first non-spherically decaying radiation into a first range of elevation angles and the second polarization current antenna is configured to emit second non-spherically decaying radiation into a second range of elevation angles that is different from the first range of elevation angles.

81. The cellular base station of claim 80, wherein the first and second polarization current antennas are configured to emit the respective first and second non-spherically decaying radiation into a full 360 degrees in the azimuth plane to provide omnidirectional coverage in the azimuth plane.

82. The cellular base station of claim 80, wherein both the first and second polarization current antennas include arc-shaped dielectric radiators that define respective arcs that lie in respective horizontal planes, and wherein the first and second ranges of elevation angles are each a range of elevation angles that is above the horizontal plane.

83. The cellular base station of claim 80, wherein the first range of elevation angles does not overlap the second range of elevation angles.

84. The cellular base station of claim 80, wherein the first range of elevation angles is smaller than the second range of elevation angles.

85. The cellular base station of claim 80, wherein the first range of elevation angles overlaps the second range of elevation angles, and wherein the first polarization current antenna is configured to receive input signals within a first frequency range and the second polarization current antenna is configured to receive input signals within a second frequency range that does not overlap with the first frequency range.

86. The cellular base station of claim 80, wherein each of the first and second ranges of elevation angles is a range that is less than 5 degrees.

87. The cellular base station of claim 80, wherein each of the first and second ranges of elevation angles is a range that is less than 2 degrees.

88. The cellular base station of claim 80, further comprising a third polarization current antenna that is configured to emit third non-spherically decaying radiation into a third range of elevation angles.

89. The cellular base station of claim 88, wherein the first range of elevation angles overlaps the second range of elevation angles, and wherein the first polarization current antenna is configured to receive input signals within a first frequency range and the second polarization current antenna is configured to receive input signals within a second frequency range that does not overlap with the first frequency range.

90. The cellular base station of claim 89, wherein the third range of elevation angles overlaps the second range of elevation angles, and wherein the third polarization current antenna is configured to receive input signals within the first frequency range.

91. A method of operating a polarization current antenna that has an arc-shaped dielectric radiator, the method comprising:
applying an electric field to the arc-shaped dielectric radiator that generates a polarization current wave within the arc-shaped dielectric radiator, wherein the speed of the polarization current wave is greater than c along both an inner radius of the arc-shaped dielectric radiator and along an outer radius of the arc-shaped dielectric radiator, where c is the speed of light in vacuum,
wherein the arc-shaped dielectric radiator includes a top surface, a bottom surface that is opposite the top surface, an inner surface, and an outer surface that is opposite the inner surface, the outer surface being longer than the inner surface, wherein the polarization current antenna further includes a plurality of electrodes that are mounted on the top surface of the arc-shaped dielectric radiator, and wherein electromagnetic radiation generated by the polarization current wave is emitted through the outer surface of the arc-shaped dielectric radiator.

92. The method of claim 91, wherein the polarization current antenna is configured so that the polarization current wave will have a first pre-selected speed at the inner radius of the arc-shaped dielectric radiator and a second pre-selected speed at the outer radius of the arc-shaped dielectric radiator, where the first and second pre-selected speeds are selected so that a beam of non-spherically decaying electromagnetic radiation that is generated by the polarization current wave has a pre-selected angular elevation beamwidth.
